(19) United States
(12) Patent Application Publication
(10) Pub. No.: US 2026/0162042 A1
(43) Pub. Date: Jun. 11, 2026

(54) SYSTEM AND METHOD OF PREDEFINING A MESSAGING STRATEGY USING AN ARTIFICIAL INTELLIGENCE MODEL

(71) Applicant: BearHug Labs Inc., San Francisco, CA (US)

(72) Inventors: Amanda Rabideau, San Francisco, CA (US); Pashmeena Noor, San Francisco, CA (US); Javeria Urooj, San Francisco, CA (US); Muhammad Sahab, San Francisco, CA (US); Burhan Mughees, San Francisco, CA (US); Saad Ali Khan, San Francisco, CA (US); Muhammad Umer, San Francisco, CA (US)

(21) Appl. No.: 19/415,995

(22) Filed: Dec. 11, 2025

Related U.S. Application Data
(60) Provisional application No. 63/730,708, filed on Dec. 11, 2024.
(60) Provisional application No. 63/912,414, filed on Nov. 6, 2025.

(51) Int. Cl. G06Q 10/0637; G06Q 30/0201

(52) U.S. Cl. CPC G06Q 10/0637; G06Q 30/02016

(57) ABSTRACT

An apparatus for generating a message framework includes a processor configured to: receive a set of documents, from a user, wherein the set of documents relates to a business; activate, based on the set of documents, a brand intelligence layer that processes and embeds business data related to the set of documents for the business to generate a sphere associated with the business and to enable the business data to be available for context-aware retrieval by an artificial intelligence model; generate, based on the set of documents and the sphere, a project brief; access, by the artificial intelligence model, the sphere for context; transmit the project brief to the artificial intelligence model; and generate, based on the project brief, the context and via the artificial intelligence model, a messaging framework, wherein the artificial intelligence model is trained on go-to-market strategies, messaging architectures, and real-world marketing nuance data.

### PRIORITY CLAIM

The present application claims priority to Provisional Ser. No. 63/730,708, filed on Dec. 11, 2024, the contents of which are incorporated herein by reference. The present application also claims priority to Provisional Ser. No. 63/912,414, filed on Nov. 6, 2025, the contents of which are incorporated herein by reference.

### TECHNICAL FIELD

The present disclosure generally relates to the use of an artificial intelligence model and more specifically to a marketing messaging generation tool that: automates the extraction of brand insights from a marketer's core documents; integrates a personalized prompt optimization layer (the “marketing brain”) to enhance output quality; produces tailored messaging frameworks using customizable large language models (LLMs); and introduces innovation via chaining inputs (audience+tone) to final messaging, always-on updates, and performance scoring.

### BACKGROUND

Messaging or branding for companies presents a challenge given the communication landscape today. Companies have to manage the details of their advertisements, social media marketing, internet advertising, television advertising, logos, and so forth. There are many challenges to getting the marketing message correct to achieve maximum benefit for the company.

Challenges include the difficulty of measuring success until a message is tested in the actual market. What may sound compelling to a company may completely miss the mark for the target audience. Whether the company focuses on the ideal customer profile (ICP), buyer persona, or target audience, there is often uncertainty until feedback comes in. The process is inherently risky, with no guarantees that the message will resonate, even after significant effort.

Crafting messaging can be a lengthy, iterative process, involving countless rounds of revisions, tweaks, and research. Often, companies are unsure about what they want, which can result in more rounds of feedback and revision than originally scoped. The normal process can lead to scope creep, where marketers are doing far more work than they are being compensated for, ultimately affecting profitability and morale.

Other issues include that, for people, the process is mentally taxing. For many marketers and communications professionals, especially those driven by external validation, there is pressure to deliver the perfect message on the first attempt. This pursuit of perfection can cause procrastination, leading to avoidance behaviors (like doing non-essential tasks) as a way to avoid the fear of delivering something subpar. The mental toll of trying to “get it right” the first time can lead to burnout, overwhelm, and delays.

While technical founders and CEOs may recognize the importance of brand messaging, the messaging package often sits lower on their priority list. When they realize it can require several hours of their time each week for months—and still with no guaranteed success—company leaders can become frustrated.

Other issues include the fact that the abstract nature of messaging causes it to be hard to pin down the right approach. Often, differing opinions amongst stakeholders can lead to conflicting feedback and make it difficult to arrive at a cohesive message. Even after crafting a solid brand message, the challenge continues with ensuring that the message stays consistent across various platforms and touchpoints—websites, social media, emails, sales collateral, and more. Inconsistent messaging can dilute the brand's identity and confuse customers, yet coordinating this consistency can be a challenge, especially across large teams or external agencies. Thus, the technical infrastructure used to disseminate messages can cause issues concerning how to craft and deploy an effective message for a company.

Further, markets evolve, and so do customer expectations. Brand messaging that resonates today may not resonate a year from now. Keeping the messaging fresh and relevant without completely overhauling the brand identity requires constant monitoring of market trends, competitor moves, and customer feedback. This ongoing need for adaptation can make it feel like the work is never truly “done.” In addition to all the points made above, many marketers for companies are being asked to do more work with fewer resources and funding. Marketing budgets have dropped quite dramatically over the past few years.

### SUMMARY

A new platform or computer-implemented tool is introduced herein. A marketing messaging generation tool is disclosed that automates the extraction of brand insights from a marketer's core documents; integrates a personalized prompt optimization layer (the “marketing brain”) to enhance output quality; produces tailored messaging frameworks using customizable large language models (LLMs); and introduces innovation via chaining inputs (audience+tone) to final messaging, always-on updates, and performance scoring.

What is needed is a platform that enables marketers to develop impactful messaging more efficiently. Several innovations are provided, including a marketing brain, a custom, pre-trained prompt enhancer that personalizes and improves LLM outputs. A project brief is a structured summary auto-generated from uploaded documents, replacing traditional question and answer intake. The approach uses audience+tone chaining, which involves enforced alignment across all messaging based on approved brand identity traits.

A system provides message effectiveness scoring using artificial intelligence (AI) prediction of messaging success rate, with explainability and strategy options. Always-on spheres involve future-facing features that enable proactive content updates based on real-world triggers. A multi-brain interface enables a pick-a-brain architecture to customize the system's behavior to different industries or marketing styles.

In some aspects, a goal of the disclosed marketing messaging generation tool is to provide a strategic, zero-to-one messaging framework. The marketing content is a derivative of and built from the marketing messaging generation tool disclosed herein. Users don't need to use another LLM outside of the marketing messaging generation tool to create content such as LinkedIn posts, emails or landing page copy. Users can generate such content on the messaging system disclosed herein.

The process begins with the system receiving an upload of core business documents, such as pitch decks, brand guidelines, and customer interviews, each tagged by type like “voice of customer” or “brand positioning.” These documents are parsed and segmented into meaningful content chunks, which are then prepared for analysis by a large language model (LLM) such as GPT, Claude, or Gemini. The model generates insights, providing summarized and actionable points extracted from the chunks. These insights are organized into an X-field messaging framework (i.e., X=16 or some other number) called a project brief, covering aspects like audience, differentiators, and positioning, forming the foundation for marketing output. Marketers can review and edit the project brief before final messaging is generated. Users can explicitly or implicitly approve critical variables, including the target audience and brand tone or voice, such as “intelligent but sarcastic,” to ensure consistency across all outputs. The inputs are chained to all downstream outputs to maintain consistency. For example, users can review and edit or regenerate the various sections of the project brief. Users can respond to questions like: (1) what does the company do?; (2) who is this for?; and (3) what makes you different.

The system generates marketing messaging aligned with the approved audience and tone using brain-enhanced prompts, resulting in robust, on-brand, and context-specific outputs. An optional scoring mechanism, integrated with a lexicon app, provides a probability of messaging success and feedback from multiple LLMs to enhance insights, allowing for A/B testing and better messaging selection. The lexicon app can be an application (mobile, desktop, or web-based) that provides access to a lexicon—which is essentially a dictionary or word list, usually specialized for a particular language, subject area, or purpose. The system can include a “spheres” concept, which continuously monitors the market for events like competitor launches, automatically updating messaging or providing recommendations. Additionally, the system can include a library of specialized “brains” for various industries, such as a pharma brain or a Taylor Swift brain, enabling users to select a brain that guides the prompt framework and insights specific to their vertical or style. The “sphere” may be implemented, by way of example, as a persistent vectorized database workspace containing embeddings of business data, metadata, and context indices for retrieval by the artificial intelligence model.

In some aspects, the techniques described herein relate to a method for generating marketing messages using an artificial intelligence-powered platform, the method including: uploading a set of business documents, each tagged by type, into a platform; parsing and segmenting the set of business documents into content chunks; analyzing the content chunks using a large language model to generate insights; organizing the insights into a structured project brief; approving a target audience and brand tone to obtain an approved audience and tone, which are chained to all downstream outputs; generating, by the platform, a marketing messaging framework aligned with the approved audience and tone using enhanced prompts; and evaluating the marketing messaging framework using a scoring mechanism to predict messaging success. For example, a marketing message for LinkedIn posts, or emails or landing page copy can be generated using the disclosed messaging system. Other messaging or social media structures or platforms can be used as well.

In some aspects, the techniques described herein relate to an apparatus for generating a message framework, the apparatus including: at least one processor; and a computer-readable medium storing instructions, which, when executed by the at least one processor, cause the at least one processor to be configured to: upload a set of business documents, each tagged by type, into a platform; parse and segment the set of business documents into content chunks; analyze the content chunks using a large language model to generate insights; organize the insights into a structured project brief; approve a target audience and brand tone to obtain an approved audience and tone, which are chained to all downstream outputs; generate, by the platform, a marketing messaging framework aligned with the approved audience and tone using enhanced prompts; and evaluate the marketing messaging framework using a scoring mechanism to predict messaging success. In some aspects, the audience and brand tone are chained, but many other components are chained as well. For example, core differentiators can be chained as well as the company description and company overview. Therefore, if a user changes one or more of these parameters, the system provides an entirely new version of the messaging framework.

In some aspects, the techniques described herein relate to a computer-readable medium storing instructions, which, when executed by at least one processor, cause the at least one processor to be configured to: upload a set of business documents, each tagged by type, into a platform; parse and segment the set of business documents into content chunks; analyze the content chunks using a large language model to generate insights; organize the insights into a structured project brief; generate, by the platform, a marketing messaging framework aligned with the approved audience and tone using enhanced prompts; and evaluate the marketing messaging framework using a scoring mechanism to predict messaging success.

In some aspects, the techniques described herein relate to a method of operating a brand messaging artificial intelligence pipeline, the method including: receiving a set of documents, from a user, wherein the set of documents relates to a business; activating, based on the set of documents, a brand intelligence layer that processes and embeds business data related to the set of documents for the business to generate a sphere associated with the business and to enable the business data to be available for context-aware retrieval by an artificial intelligence model; generating, based on the set of documents and the sphere, a project brief; accessing, by the artificial intelligence model, the sphere for context; transmitting the project brief to the artificial intelligence model; and generating, based on the project brief, the context and via the artificial intelligence model, a messaging framework, wherein the artificial intelligence model is trained on go-to-market strategies, messaging architectures, and real-world marketing nuance data.

In some aspects, the techniques described herein relate to an apparatus for generating a message framework, the apparatus including: at least one processor; and a computer-readable medium storing instructions, which, when executed by the at least one processor, cause the at least one processor to be configured to: receive a set of documents, from a user, wherein the set of documents relates to a business; activate, based on the set of documents, a brand intelligence layer that processes and embeds business data related to the set of documents for the business to generate a sphere associated with the business and to enable the business data to be available for context-aware retrieval by an artificial intelligence model; generate, based on the set of documents and the sphere, a project brief; access, by the artificial intelligence model, the sphere for context; transmit the project brief to the artificial intelligence model; and generate, based on the project brief, the context and via the artificial intelligence model, a messaging framework, wherein the artificial intelligence model is trained on go-to-market strategies, messaging architectures, and real-world marketing nuance data.

In some aspects, the techniques described herein relate to a computer-readable medium stores instructions, which, when executed by at least one processor, cause the at least one processor to be configured to: receive a set of documents, from a user, wherein the set of documents relates to a business; activate, based on the set of documents, a brand intelligence layer that processes and embeds business data related to the set of documents for the business to generate a sphere associated with the business and to enable the business data to be available for context-aware retrieval by an artificial intelligence model; generate, based on the set of documents and the sphere, a project brief; access, by the artificial intelligence model, the sphere for context; transmit the project brief to the artificial intelligence model; and generate, based on the project brief, the context and via the artificial intelligence model, a messaging framework, wherein the artificial intelligence model is trained on go-to-market strategies, messaging architectures, and real-world marketing nuance data.

In some aspects, the processes described herein (e.g., processes described herein) may be performed by a computing device or apparatus or a component or system (e.g., a chipset, one or more processors (e.g., CPU, GPU, NPU, DSP, etc.), ML system such as a neural network model, etc.) of the computing device or apparatus. In some aspects, one or more of the apparatuses described herein is, is part of, and/or includes any kind of apparatus, a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus further includes a display for displaying one or more user interfaces, images, notifications, and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing and other features and aspects will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example system for generating a messaging framework or messaging intelligence ecosystem, according to aspects of the disclosure;

FIG. 2 is a diagram illustrating an example of the various user interfaces and actions associated with the system, according to aspects of the disclosure;

FIG. 3 is a flow diagram illustrating a method of operating an artificial intelligence-powered platform to generate marketing content, according to aspects of the disclosure;

FIG. 4 is a flow diagram illustrating a method of operating a brand messaging artificial intelligence pipeline, according to aspects of the disclosure;

FIG. 5A illustrates an example user interface for providing a social media posting or message generation, according to aspects of the disclosure;

FIG. 5B illustrates an example user interface for providing a language page, according to aspects of the disclosure;

FIG. 6A illustrates an example method for generating social media or email content, according to aspects of the disclosure.

FIG. 6B illustrates an example method related to using a landing page for operating a marketing campaign, according to aspects of the disclosure;

FIG. 6C illustrates an example method for generating a messaging framework, according to aspects of the disclosure; and

FIG. 7 is a diagram illustrating an example of a computing system, according to aspects of the disclosure.

### DETAILED DESCRIPTION

Certain aspects of this disclosure are provided below. Some of these aspects may be applied independently, and some of them may be applied in combination, as would be apparent to those of skill in the art. In the following description, specific details are set forth to provide a thorough understanding of aspects of the application. However, it will be apparent that various aspects may be practiced without these specific details. The figures and descriptions are not intended to be restrictive.

The ensuing description provides example aspects only, and is not intended to limit the scope, applicability, or configuration of the disclosure. Rather, the subsequent description of the example aspects will provide those skilled in the art with an enabling description for implementing an example aspect. It should be understood that various changes may be made in the function and arrangement of elements without departing from the spirit and scope of the application as set forth in the appended claims.

There is over $380B wasted annually on marketing campaigns that fail to resonate with customers. Marketers are flying blind, relying on outdated workflows, disconnected inputs, and generic AI tools that guess instead of guiding.

The future of marketing messaging lies in predictive intelligence, strategic automation, and vertical customization. This disclosure introduces the world's first messaging intelligence ecosystem that is a living system that evolves with a brand, predicts performance before launch, and is powered by modular, AI-driven marketing brains.

The disclosed system or marketing messaging generation tool automates the extraction of brand insights from a marketer's core documents. The system can integrate a personalized prompt optimization layer (the “marketing brain”) to enhance output quality and produce tailored messaging frameworks using customizable large language models (LLMs). The system can introduce innovation via chaining inputs (audience+tone) to final messaging, always-on updates, and performance scoring.

Examples of artificial intelligence models include OpenAI, ChatGPT, Google Gemini, Grok, Kimi, and so forth. The particular type of artificial intelligence model can vary. It can include a large language model (LLM), a computer vision model, a multimodal model, an open-source model or any other kind of model or combination of models that will receive the disclosed data package that includes both data and instructions for taking actions on the data to generate either the messaging framework or to re-generate a portion of the messaging framework. In some cases, the front-end platform disclosed herein will communicate with the artificial intelligence model via an application programming interface (API) or may enter data into input fields on behalf of the users of the front-end platform such that the users are not directly interacting with the artificial intelligence model but are enabled to obtain the results they desire through a user interface of the front-end platform.

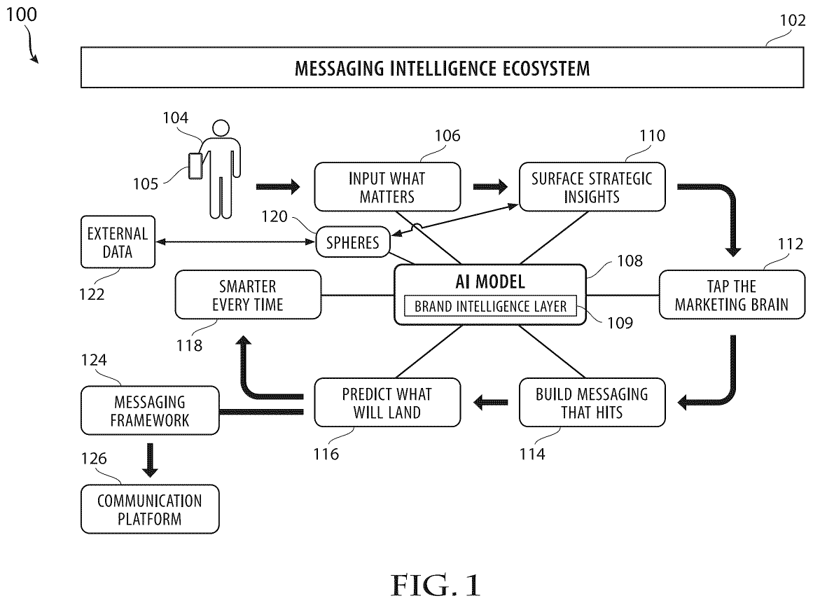

FIG. 1 is a diagram illustrating a system 100 for generating a messaging framework. The system 100 can include a messaging intelligence ecosystem 102 that has various components.

The system can include a user device 105 operated by a user 104. The user device 105 can be a computing system 700 or any device accessing a network and the messaging intelligence ecosystem 102. The process begins with the upload of core business documents, such as pitch decks, brand guidelines, and customer interviews. Block 106 represents the first step of inputting what matters to a marketing strategy. Each document can be tagged by type. The “type” can mean various things, such as a “voice of the customer” or “brand positioning.” The input documents are provided as structured inputs. In some cases, a questionnaire can be provided. In other aspects, rather than a traditional questionnaire, the strategic intake is designed to synthesize a brand's DNA. Requested inputs can include one or more of: client survey data; a sales pitch deck; brand guidelines; a voice of customer call transcripts; a scope of work or project brief; a demo recording (if available); and/or an internal call with the agency or marketing team. For example, such calls can be recorded, transcribed, or processed further by an artificial intelligence model to obtain visual data.

In general, the system 100 can provide an example of a client project workflow. The client project workflow can include creating a client by uploading materials such as pitch decks, brand guidelines, or call transcripts through a user device 105. The uploads form the initial inputs of the system, corresponding to block 106 in which the user can input what matters. Each uploaded document is processed and stored within the system's brand-intelligence layer 109 and may be supplemented by answers to questionnaires either provided directly by the marketer or by the client. This stage ensures that the brand's foundational data—audience, tone, differentiators, and goals—are clearly captured for downstream processing.

Once the client has been created, the user can create a client project as a child of that client, narrowing the marketing task to a specific campaign, product, or objective. The client project inherits contextual data from the parent client while adding its own unique inputs, such as campaign goals or stage-specific details (e.g., awareness, repositioning). The user can upload additional documents or fill in questionnaire responses tied specifically to this client project. These combined inputs are normalized and prepared for further processing by the marketing brain when the process involves tapping the marketing brain 112—a coordinated orchestration layer over the AI model 108 and brand-intelligence layer 109.

With the necessary client and client project data collected, the system generates a project brief, a structured synthesis of the most relevant information. This corresponds to the intermediate stage of tapping the marketing brain 112 to extract and summarize key insights from the uploaded materials and questionnaire responses. The project brief divides the information into logical sections—such as target audience, tone of voice, company overview, differentiators, and positioning—and provides editable content for marketer review. When new documents are uploaded or existing sections are refined, the system can generate updated versions of the project brief automatically.

After the marketer approves the project brief, the system generates a messaging framework, corresponding to the output or a messaging framework 124 of FIG. 1. The messaging framework contains sections (i.e., 2-20 sections or more) that detail the brand's story, voice, and differentiators, all aligned with the approved tone and audience. Each section can be refined individually or in total using a “regenerate all” capability. Because foundational sections like tone of voice, target audience, and company overview are chained to multiple downstream components, editing any of these will automatically generate a new, version-controlled messaging framework.

Finally, the approved messaging framework can be used to create content assets for distribution through the communication platform 126. The communication platform 126 represents any number of different platforms, such as LinkedIn, which can host LinkedIn posts, an email system (subject, preview text, body, and CTA), and a webpage or application for landing page content. Each asset inherits the tone, audience, and structure defined within the messaging framework. The marketer can preview, regenerate, and approve these assets, then export them as client-ready deliverables. This closed-loop workflow—from input what matters in block 106 to tapping the marketing brain 112 to generating messaging framework 124 and deploying through the communication platform 126—embodies the complete system flow of FIG. 1.

The input documents are parsed and segmented into meaningful content chunks, which are then prepared for analysis by an artificial intelligence (AI) model such as AI model 108, a large language model (LLM) such as GPT, Claude, or Gemini. Block 110 represents processes to surface strategic insights from the input documents. The AI model 108 generates insights, providing summarized and actionable points extracted from the chunks. These insights are organized into an X-field messaging framework (i.e., X=5 or 16 or some other number) called a project brief, covering aspects like audience, differentiators, and positioning, forming the foundation for marketing output.

As shown in block 110, the system 100 extracts the most important information or insights from the input documents to build the project brief for that particular user. The system 100 converts unstructured brand input materials in the input documents into strategic insights and then into a project brief. The project brief can be a strategic bridge between client-provided materials and downstream AI-generated brand messaging. The project brief does the following. The project brief provides an overview of the business and structured summaries that synthesize key attributes such as tone, audience, positioning, and differentiators. The project brief references the usefulness of the data. The project brief is clear, editable, and useful to marketers before prompt execution. In some aspects, the system also supports regeneration of the marketing framework based on one or more parameters. The project brief enables downstream integration and is the primary input layer for the system's full brand messaging pipeline.

The system 100 can include a “spheres” concept. A spheres module 120 continuously monitors external data 122, such as the market, news, competitor information, etc., for events like competitor launches, automatically updating messaging or providing recommendations. The spheres module 120 can also hold all the information/documents/questionnaires or other data that the user has uploaded. The creation of the project brief can include data from the spheres module 120. The AI model 108 can transform unstructured brand inputs from the spheres module 120 within a vector database into a structured, editable, and useful project brief. The system disclosed herein can generate structured summaries that synthesize key attributes such as target audience, tone, personality, core differentiators, positioning, key messaging themes, emotional drivers, company description, and notable brand quotes. The system 100 can implement individualized prompts to extract the specific insights from the embedded client data, survey summaries, and any other data stored with the spheres module 120. A user interface on the user device 105 can display the generated project brief and allow marketers to review and edit it before prompt execution. The system 100 supports outputting the project brief in JSON and markdown formats.

In connection with block 110, the system 100 can activate a brand intelligence layer 109, which stores everything it learns, enabling contextual, consistent messaging that sharpens over time. Block 110, surface strategic insights, can be part of the spheres module 120 as well. The marketing brain may include or be implemented by the AI model 108 executing prompt optimization routines, whereas the brand intelligence layer 109 can be configured to store contextual embeddings and historical outputs. Marketers can review and edit the project brief through a user interface before final messaging is generated. Users can explicitly approve critical variables, including the target audience and brand tone or voice, such as “intelligent but sarcastic,” to ensure consistency across all outputs. The inputs are chained to all downstream outputs to maintain consistency.

After reviewing and approving the project brief by the user 104, the system 100 utilizes the project brief, which itself has a number of sections (i.e., five sections), as well as descriptive target audience and a custom brand voice model, to generate the messaging framework 124 on top of the project brief. The user 104 can edit these outputs and approve them directly in-platform. Once finalized, user 104, by interacting with user device 105, can click on a “Generate Messaging” object, and the system produces the X-section custom messaging framework tailored to the audience and voice. The messaging framework 124 includes positioning, company description, brand promise, core differentiators, taglines, headlines, and more-all linked together and context-aware. The messaging framework 124 can be downloaded in a certain format such as PDF or Microsoft Word (or other formats) in some aspects.

The user 104 can also request the system 100 generate multiple versions of the framework and use resonance scoring to evaluate each one. In this regard, rather than determining, “I like this one better,” the user 104 can determine, “This one scores highest for our audience, based on actual goals and context.” Rather than having a subjective conversation, the user 104 makes data-driven decisions.

The AI model 108 and/or the brand intelligence layer 109 can be characterized as a “marketing brain.” At the heart of system 100 is the AI model 108, which is trained on decades of go-to-market strategies, messaging architecture, and real-world marketing nuance.

The AI model 108 provides proprietary brand strategy insights into AI prompting that would meaningfully improve the quality and distinctiveness of messaging outputs. The primary differentiation of AI model 108 is twofold. It strengthens content by incorporating strategic frameworks directly into the prompt design to increase brand fidelity, depth, and relevance.

The AI model 108 enhances an execution architecture. The AI model 108 redesigns how prompts are structured and delivered to maximize model focus, allows dynamic input layering, and improves logical coherence across outputs. For example, instead of treating prompts as a large static block, the system 100 treats each brand messaging framework field as an individualized generation step, allowing for finer control, greater specificity, and better integration of intermediate outputs through chaining. The dual focus on content and execution is important in pushing the quality ceiling beyond what static prompt improvements alone could achieve. The system 100 may also couple a few sets of data together at once in some cases. The new system is the blueprint for building a more modular, scalable, and proprietary marketing generation system inside system 100. The system 100 can include a full library of modular brains, so the user 104 can choose the one that best fits their project or client. Rather than simply being templates, each modular brain would be a respective full-stack marketing mind trained on vertical and stylistic specificity.

For example, an industry could establish a modular brain. A pharma/med devices brain could be built for compliance-heavy storytelling with high technical accuracy. The module brain could be organized by style. A performance marketer's brain could prioritize funnels, A/B test logic, and high-conversion copy.

Block 112 taps the marketing brain or AI model 108 and/or the brand intelligence layer 109. It generates marketing messaging aligned with the approved audience and tone using brain-enhanced prompts, resulting in robust, on-brand, and context-specific outputs. An optional scoring mechanism, integrated with a lexicon app, provides a probability of messaging success and feedback from multiple LLMs to enhance insights, allowing for A/B testing and better messaging selection. The lexicon app can be an application (mobile, desktop, or web-based) that provides access to a lexicon, essentially a dictionary or word list, usually specialized for a particular language, subject area, or purpose.

Additionally, the system 100 can include a library of specialized “brains” for various industries, such as a pharma brain or a Taylor Swift brain, enabling users to select a brain that guides the prompt framework and insights specific to their vertical or style.

Block 114 represents the result of the built messaging “hits,” meaning it is effective and focused for the client's brand. Based on the approved project brief, the system 100 generates a descriptive target audience and a custom brand voice model. It produces a comprehensive X-section custom messaging framework (e.g., positioning, company description, brand promise, core differentiators, taglines, headlines) displayed top the user 104. The system 100 can implement “Prompt Individualization,” in which each field is generated via its own dedicated prompt, and “Prompt Chaining,” in which outputs from earlier fields are injected into later prompts as structured context. The system 100 can also ensure “footer injection” of standardized contextual information (e.g., client survey answers, brand summaries) into each prompt for consistency.

Block 116 represents an optional approach of predicting what will land. The system can include predictive resonance scoring for a pre-market validation of the marketing framework.

Block 118 represents that the AI model 108 is smarter every time it is used. The AI model 108 draws from user inputs and refines its understanding, so each project gets sharper, faster, and more accurate.

The system can also include a component that provides advanced messaging generation for diverse marketing assets. For example, internet web page landing pages, emails, texts, paid ads, social media postings and accounts, tweets on X, etc. These can be text, images, video, multimodal content, and so forth that can be generated all with the consistency that fits the marketing framework.

The foregoing description of FIG. 1 provides an overview of an example messaging intelligence ecosystem 100 and the interactions among its core functional layers. To further illustrate how these components cooperate in practice, the following section describes the system architecture in greater detail. The system example embodiment integrates the user device, artificial-intelligence model, brand-intelligence layer, and sphere into a unified computing platform that supports the generation, evaluation, and refinement of marketing messaging frameworks. The description below expands upon the high-level elements shown in FIG. 1 to provide structural context for the claimed system implementation.

The techniques described herein relate to a system for generating a messaging framework 124. As illustrated in FIG. 1, the system 100 may include a user device 105 communicatively coupled to a server or computing platform that hosts an AI model 108, a brand-intelligence layer 109, and a sphere module 120 associated with a particular business or brand. The user device 105 can include any computing device, such as a desktop computer, laptop, tablet, or mobile phone, configured to receive a set of documents from a user. The set of documents may include, without limitation, pitch decks, brand guidelines, survey responses, customer interview transcripts, or other materials that represent the business's identity, tone, or positioning. The user device 105 communicates these documents to the server or computing platform for processing and message generation.

The AI model 108 may be trained on go-to-market strategies, messaging architectures, and real-world marketing nuance data. The model may include or interface with one or more LLM components capable of performing contextual language analysis, prompt interpretation, and text generation. The brand-intelligence layer 109 operates in conjunction with the AI model 108 to process and embed business data derived from the uploaded documents, thereby generating the sphere module 120. The sphere module 120 functions as a persistent workspace or vectorized data repository that stores structured embeddings of brand-specific information. This arrangement enables context-aware retrieval of relevant data by the AI model 108 during subsequent message generation and refinement operations.

A messaging-generation engine operatively connects to the AI model 108 and the brand-intelligence layer 109. The messaging-generation engine is configured to: (i) generate, based on the set of documents and the sphere module 120, a project brief that contains structured summaries synthesizing one or more of a target audience, a brand tone, a differentiator, and positioning data for the business; (ii) transmit the project brief to the AI model 108 for contextual analysis; and (iii) generate, based on the project brief and the contextual information retrieved from the sphere module 120, a messaging framework 124 aligned with an approved audience and tone. The resulting messaging framework may include multiple linked sections such as positioning statements, taglines, headlines, brand promises, or value propositions.

The system 100 may further include a resonance-scoring module configured to evaluate the messaging framework 124 using a probabilistic or machine-learning model trained on engagement metrics, campaign goals, and audience parameters. The resonance-scoring module produces a resonance or success-likelihood score that predicts how effectively the generated messaging is expected to perform with its intended audience.

A feedback module may store and apply the resonance data and user approvals or edits to refine subsequent message generation. The feedback module updates the sphere module 120 and the brand-intelligence layer 109 so that future iterations of the messaging framework 124 benefit from prior results, thereby creating a closed-loop learning system. In some embodiments, the feedback module can automatically modify prompt parameters or weightings used by the AI model 108 to enhance future outputs.

In certain implementations, the system 100 may also include additional components such as: a library of modular marketing brains, each specialized for a respective industry or style (e.g., pharmaceutical, retail, or entertainment domains); a user-interface layer configured to present the project brief, resonance-scoring results, and messaging frameworks for review, editing, and approval; and one or more application-programming interfaces (APIs) enabling integration of the system 100 with third-party marketing, analytics, or campaign-deployment platforms.

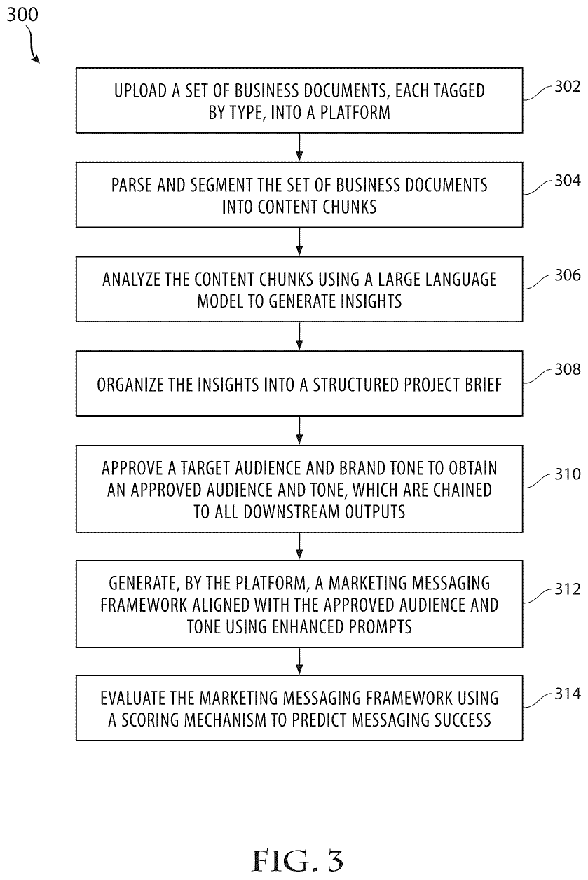

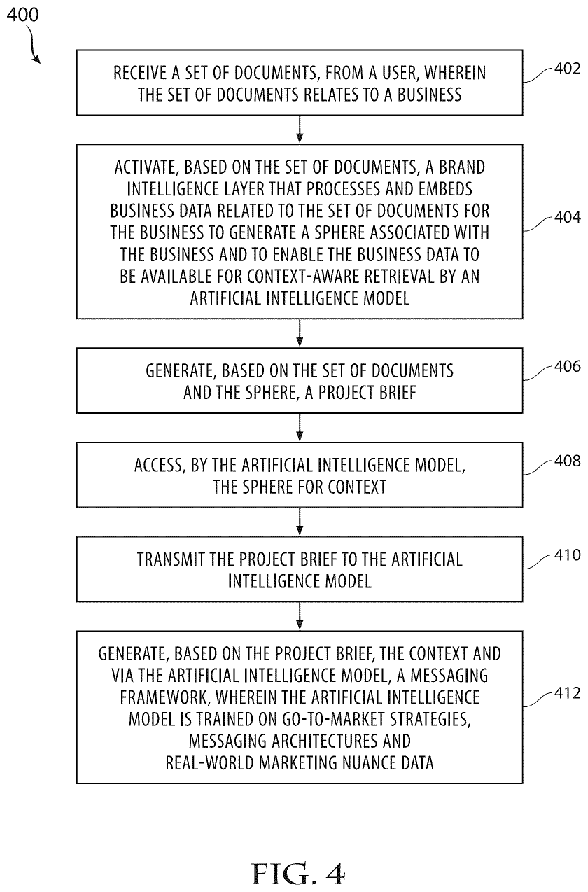

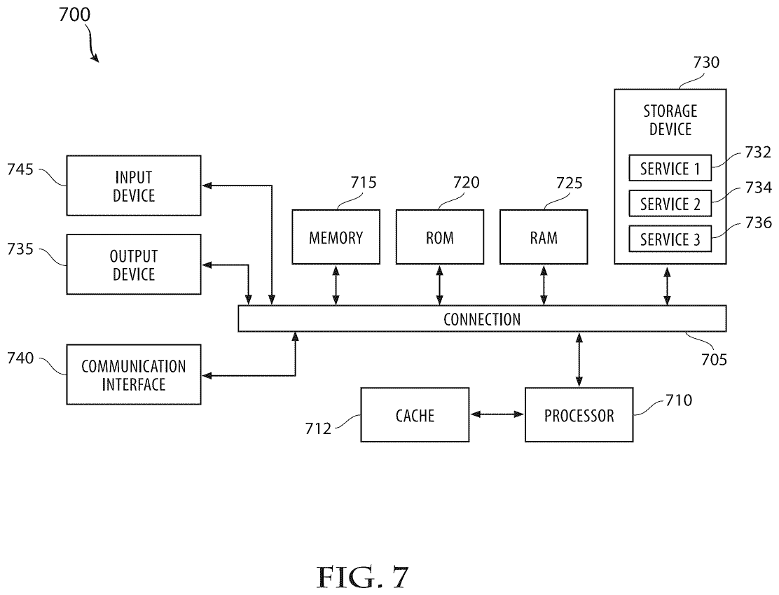

The components of the system 100 may be distributed across cloud-based servers, edge devices, or hybrid environments and may communicate through wired or wireless network interfaces. The system architecture described herein may operate in coordination with the methods illustrated in FIGS. 3 and 4, and the computing environment shown in FIG. 7.

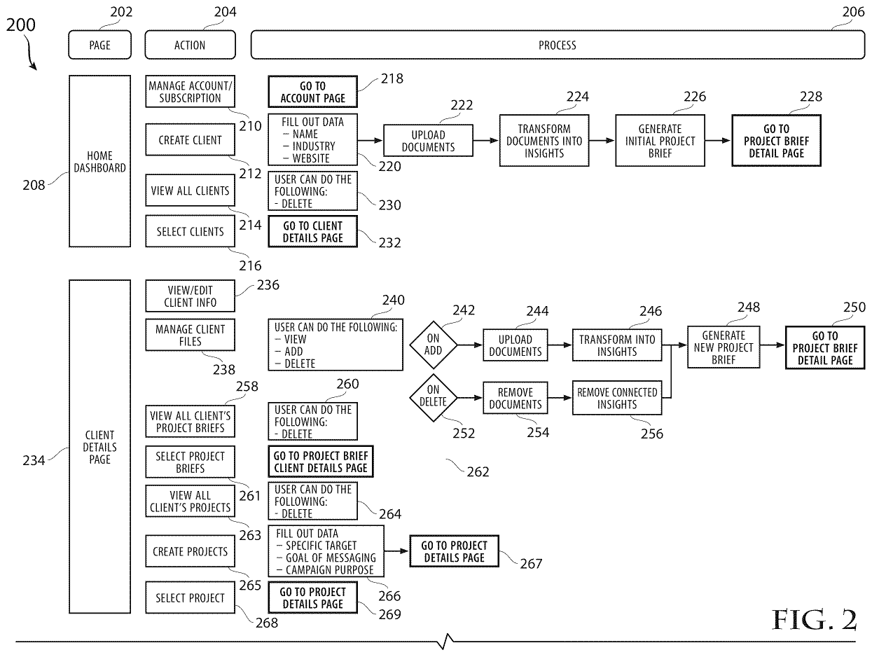

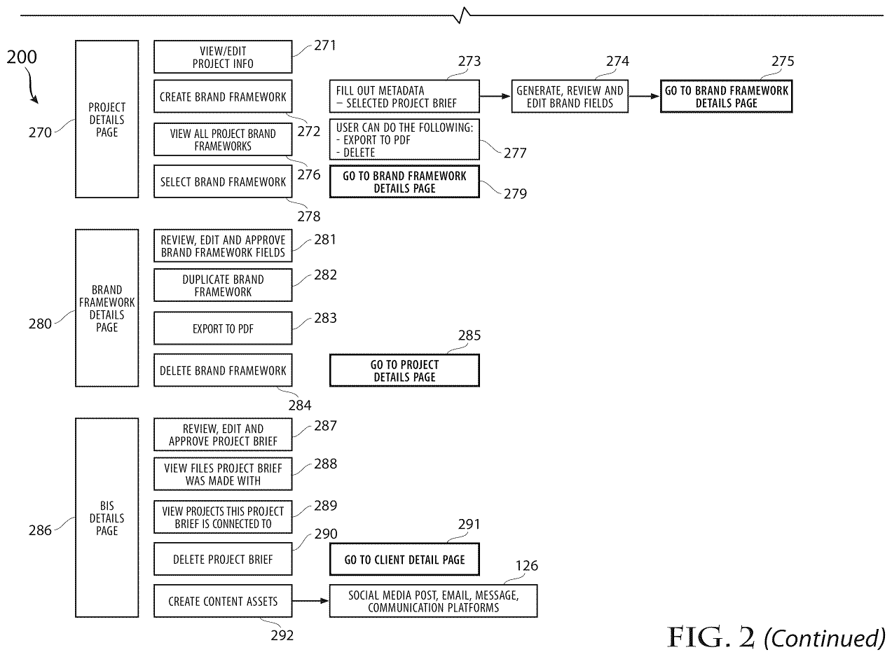

FIG. 2 is a diagram illustrating various pages, actions, and processes 200 to the system 100, according to aspects of the disclosure. FIG. 2 illustrates the interactions between a page 202, the backend action 204, and the process 206 implemented when a user interacts with the page 202. For example, a home dashboard 208 can be a user interface with various objects the user can interact with. When the user selects a manage account/subscription object 210, process 206 can go to an account page 218. A create client object 212 can implement a process to fill out data 220 and then enable the user to upload documents 222, where the system will transform documents into insights 224 and generate the initial project brief 226. The process 206 can then proceed to the project brief detail page 228. For instance, when the user uploads brand guidelines and customer survey transcripts, the system can identify key tone descriptors such as “confident yet empathetic” and embed them into the sphere for context-aware message generation. The user can interact with an object to view all clients 214 and perform actions such as deleting a client 230 or performing other processes. The user can interact with an object to select clients 216, which will cause the system to proceed to a client details page 232.

A client details page 234 can provide various objects for a user to interact with to take an action 204. An object to view/edit client information 236 can be provided. An object to manage client fields 238 can enable the user to view, add or delete 240 files. On add 242, the process 206 can include the ability to upload documents 244, transform the documents into insights 246, and generate a new project brief 248. The user can interact with an object on the project brief detail page 250. On delete 252, the system can remove documents 254 and remove the connected insights 256 to the removed documents.

The user can interact with an object to view all client project briefs such as project brief 258 and can delete 260 one or more project brief or perform other actions. The user can select project brief 261 and a project brief client details page 262. The user can view all client products 263 and delete 264 a client product or perform other actions. The user can interact with an object to create a project 265 and fill out data 266, such as a specific target, goal of messaging, and campaign purpose (as well as other input), and go to a project details page 267. The user can select a project 268 and then go to the project details page 269.

A project details page 270 can include an object to view/edit project information 271 and interact with an object to create a brand framework 272. In that case, the user can fill out metadata on a selected project brief 273 and generate, review, and edit brand fields 274. The user can then go to a brand framework details page 275. The user can interact with an object to view all project brand frameworks 276 and export to PDF, delete 277 a brand framework, or perform other actions. An object can be interacted with to select a brand framework 278 and then go to a brand framework details page 279.

A brand framework details page 280 includes objects that the user can interact with to review, edit, and approve brand framework fields 281, duplicate a brand framework 282, export a brand framework to PDF 283, delete a brand framework 284, and go to a project details page 285.

A project brief details page (PB details page 286) can include several objects that a user can interact with, including objects to review, edit, and approve a project brief 287, view files the project brief was made with 288, view projects this project brief is connected to 289, and delete a project brief 290, where the user can go to the client detail page 291. The pages, actions, and processes shown in FIG. 2 are described by way of example, and other pages, actions, and processes can be included as well.

The process includes creating content assets 292 or a messaging framework that can be output as a social media post, email, or message or provided to a communication platform 126 for distribution.

FIG. 3 illustrates an example of a process 300 for operating a messaging intelligence ecosystem 102. The process 300 can include generating marketing content using an artificial intelligence-powered platform. The process 300 can be performed by an apparatus, such as one or more of the system 100, a user device 105, the AI model 108, a computing device 700, a computer processor such as processor 710, and/or any subcomponents thereof.

At block 302, the apparatus (i.e., one or more of the system 100, the user device 105, the AI model 105, the computing device 700, the computer processor, such as processor 710, and/or any subcomponents thereof) can be configured to upload a set of business documents, each tagged by type, into a platform. The set of business documents can include one or more of pitch decks, brand guidelines, and customer interviews.

At block 304, the apparatus can be configured to parse and segment the set of business documents into content chunks. A user-selectable large language model can prepare the content chunks for analysis.

At block 306, the apparatus can be configured to analyze the content chunks using a large language model to generate insights.

At block 308, the apparatus can be configured to organize the insights into a structured project brief. In some aspects, the structured project brief can include fields such as one or more of an audience field, a differentiator field, a positioning field, and a brand tone.

At block 310, the apparatus can be configured to approve a target audience and brand tone to obtain an approved audience and tone, which are chained to all downstream outputs.

At block 312, the apparatus can be configured to generate, by the platform, a marketing messaging framework aligned with the approved audience and tone using enhanced prompts. In some aspects, the enhanced prompts can be generated using a marketing brain that includes a custom, pre-trained artificial intelligence prompt enhancer.

At block 314, the apparatus can be configured to evaluate the marketing messaging framework using a scoring mechanism to predict messaging success. The scoring mechanism can provide a probability of messaging success and allows for A/B testing and better messaging selection.

The process 300 can include allowing marketers to review and edit the structured project brief before a final messaging framework is generated. The process 300 can also include continuously monitoring an external market using a sphere component to update messaging or provide recommendations when relevant events occur automatically.

In some aspects, the platform can include a library of brains for various industries, allowing users to select a respective brain to guide a prompt framework and provide insights specific to a vertical or marketing style. In some aspects, the process 300 can further include integrating feedback from multiple large language models to enhance insight generation.

In some aspects, an apparatus is disclosed for generating a message framework. The apparatus can include at least one processor, and a computer-readable medium storing instructions, which, when executed by the at least one processor, cause the at least one processor to be configured to: upload a set of business documents, each tagged by type, into a platform; parse and segment the set of business documents into content chunks; analyze the content chunks using a large language model to generate insights; organize the insights into a structured project brief; approve a target audience and brand tone to obtain an approved audience and tone, which are chained to all downstream outputs; generate, by the platform, a marketing messaging framework aligned with the approved audience and tone using enhanced prompts; and evaluate the marketing messaging framework using a scoring mechanism to predict messaging success.

In some aspects, a computer-readable medium (i.e., a memory 715, ROM 720, RAM 725 or other computer-readable medium) stores instructions, which, when executed by at least one processor, cause the at least one processor to be configured to: upload a set of business documents, each tagged by type, into a platform; parse and segment the set of business documents into content chunks; analyze the content chunks using a large language model to generate insights; organize the insights into a structured project brief; approve a target audience and brand tone to obtain an approved audience and tone, which are chained to all downstream outputs; generate, by the platform, a marketing messaging framework aligned with the approved audience and tone using enhanced prompts; and evaluate the marketing messaging framework using a scoring mechanism to predict messaging success.

FIG. 4 illustrates an example of a process 400 for operating a messaging intelligence ecosystem 102. Process 400 can relate to operating a brand messaging artificial intelligence pipeline. Process 400 can be performed by an apparatus, such as one or more of the system 100, a user device 105, the AI model 108, a computing device 700, a computer processor such as processor 710, and/or any subcomponents thereof.

At block 402, the apparatus (i.e., one or more of the system 100, the user device 105, the AI model 105, the computing device 700, the computer processor such as processor 710 and/or any subcomponents thereof) can be configured to receive a set of documents, from a user, wherein the set of documents relates to a business. The set of documents is editable by the system 100 and is configured to be provided downstream to an artificial intelligence marketing model, such as AI model 108. The set of documents can be one or more of client survey data, a sales pitch deck, brand guidelines, a video, an audio file, a voice of customer call transcripts, a scope of work, a project brief, a demonstration recording, or an internal call with an agency or marketing team.

The AI model 108 can be a selected artificial intelligence model selected from a group of artificial intelligence models in which each artificial intelligence model of the group of artificial intelligence models is trained on specific industries or styles for marketing purposes.

At block 404, the apparatus can be configured to activate, based on the set of documents, a brand intelligence layer that processes and embeds business data related to the set of documents for the business to generate a sphere associated with the company and to enable the business data to be available for context-aware retrieval by an artificial intelligence model. In some aspects, the business data can include the set of documents and one or more of past messaging, inputs, frameworks, and iterations of data such that the sphere includes a persistent workspace that is accessed by the artificial intelligence model for the context when generating the messaging framework 124.

The set of documents can include content in diverse file formats, and the system can be configured to generate the project brief by preprocessing the set of documents into text chunks.

In some aspects, the sphere (or sphere module 120) is stored in a vector database, and the set of documents is transformed from unstructured brand-related inputs into the sphere. The sphere can include a target audience and one or more of the brand tone and the brand voice. Further, the sphere can be chained to all downstream outputs to maintain consistency over the target audience, the brand tone, or the brand voice.

At block 406, the apparatus can be configured to generate a project brief based on the set of documents and the sphere. The project brief can include or be structured as a summary of the set of documents. The project brief can synthesize one or more of a tone, an audience, positioning data, and a market differentiator for the business. In some aspects, the structured summaries in the project brief synthesize key attributes, including one or more of a target audience, a brand tone, a personality, one or more core differentiators, a positioning, a key messaging theme, an emotional driver, a company description, and a notable brand quote.

At block 408, the apparatus can be configured to access, by the artificial intelligence model, the sphere for context.

At block 410, the apparatus can be configured to transmit the project brief to the artificial intelligence model.

At block 412, the apparatus can be configured to generate, based on the project brief, the context, and via the artificial intelligence model, a messaging framework 124, wherein the artificial intelligence model is trained on go-to-market strategies, messaging architectures, and real-world marketing nuance data. The process 400 can include receiving, with or without edits by the user, a confirmation of the project brief from the user before generating the messaging framework 124.

In some aspects, the process 400 can include presenting the project brief to the user for revision and receiving revisions to the project brief before transmitting the project brief to the artificial intelligence model.

In some aspects, the process 400 can further include before generating the messaging framework 124: presenting, based on the project brief and from the artificial intelligence model, a brand tone and a target audience to the user based on the project brief; receiving one or more of edits to the brand tone or the target audience and a confirmation of the brand tone and the target audience; and updating, if relevant, prompts to the artificial intelligence model based on any edits to the brand tone or the target audience for generation of the messaging framework 124. The messaging framework 124 can include a multi-section brand messaging framework. Each field of the messaging framework 124 can be generated via a separate dedicated prompt to the artificial intelligence model.

The method 400 can further cause the system to be configured to maintain a hierarchical client-project structure, wherein each client account comprises a plurality of associated projects, each project defining a distinct messaging objective or campaign scope. Each client and project record can include respective metadata identifying one or more brand files, prior messaging frameworks, and performance metrics retrievable by the artificial-intelligence model for context-aware generation.

In some aspects, the system can enable collaborative access by multiple users to a shared client or project workspace. In such a case, edits, approvals, and comments from different users can be stored as session-linked collaboration data.

A shared workspace can provide real-time synchronization of user comments, revisions, and approval states through an in-app messaging or chat interface.

In some aspects, the method 400 can cause the system to be configured to lock one or more sections of the messaging framework 124 responsive to user approval or scheduling inputs to prevent further editing before client delivery or for transmission through a communication platform or social media platform. The system may provide, through a user interface, an adaptive prompt-assistance module that dynamically suggests or modifies prompts to the artificial-intelligence model based on the user's edits, the approved brand tone, and prior outputs.

In some aspects, the adaptive prompt-assistance module analyzes semantic differences between user edits and model outputs to refine subsequent prompt parameters.

The platform can aggregate user feedback and resonance scores across multiple clients to update prompt templates and weighting factors for the artificial-intelligence model.

Further, the system can be configured to schedule automatic regeneration of messaging frameworks at predetermined intervals or upon detection of external data updates in the sphere module. The regeneration process or regeneration even can create versioned frameworks linked to their originating audience and tone approvals, enabling auditability and longitudinal comparison of messaging performance.

In some aspects, the multi-section brand messaging framework can include any two or more of: Target Audience (The people the company wants to reach); Brand Personality (The brand's consistent human-like character); Brand Tone of Voice (How that personality is expressed); Core Differentiators (What makes the company unique from competitors); Company Category (The specific industry the company operates in). Company Description (What the business does and for whom); Brand Promise (The company commitment and legacy to customers); Brand Promise Benefits (How the company commitment helps its customers); Brand Pillars (Three reasons customers choose the company); Pillar Benefits (Why each pillar matters to customers); Elevator Pitch (The quick, concise product story); Positioning Statement (Why the company's product is the best solution); Value/Benefit to Customer (The worth the company bring to the customer); Description of Value (Explaining the worth the company brings); Value Proposition (The key reason to choose the company); Tagline (The company inspiring, memorable brand statement); and Headline (A brief, attention-grabbing title).

Each of these elements is discussed next in more detail. System 100 includes a target-audience modeling module that analyzes demographic, psychographic, and professional data to define messaging recipients most likely to benefit from AI-guided communications. For example, the system may identify intermediate marketing professionals, freelancers, or agency owners who experience time constraints and require structured tools to craft high-converting client messaging. Using natural-language understanding and behavioral heuristics, system 100 generates persona profiles capturing audience pain points, goals, and vocabulary preferences, thereby enabling subsequent modules to align tone, word choice, and content structure with the expectations of that audience segment.

A company-overview generator of system 100 compiles concise, differentiating summaries of a user's business within a selected category such as “AI-powered messaging intelligence.” Through guided prompts and context analysis, the system extracts descriptors that convey both capability and market position. Example output may describe a platform that empowers marketers to transform uncertainty into confidence by eliminating guesswork through structured, AI-assisted message testing. The resulting overview functions as a foundation dataset referenced by other modules—particularly positioning, promise, and tagline generation—to maintain narrative consistency across all generated assets.

System 100 provides an elevator-pitch synthesis engine configured to condense the company overview and value proposition into one or more short, high-impact narrative statements. The engine can produce both standard and creative variants. For instance, one version may state that system 100 “helps marketing freelancers and agencies craft high-converting messages through a guided, AI-powered process,” while an alternate creative variant may emphasize cutting through industry noise and replacing guesswork with data-driven precision. The elevator-pitch outputs are stored as concise templates usable in presentations, marketing collateral, or automated campaign messaging.

System 100 integrates a tone-and-personality module that governs the stylistic and emotional consistency of generated language. A brand-voice statement defines the overarching character of communications—for example, positioning the system 100 as a savvy, supportive partner offering clear, data-backed guidance. Sub-modules encode multiple voice pillars, such as “Empowering Expert,” which conveys confidence and encouragement, and “Pragmatic Partner,” which stresses practical empathy and time-saving clarity. A persona/archetype engine can instantiate recognizable archetypes—such as an “Oprah-like” mentor persona—to modulate empathy and accessibility parameters. The module further enforces language-rule constraints specifying preferred active-voice syntax, benefit-oriented phrasing, avoidance of jargon, and adaptive “tone-dialing” for different communication contexts. Collectively, these sub-systems ensure that every AI-generated sentence conforms to the desired brand temperament.

A positioning-statement constructor within system 100 formulates concise declarations situating the user's offering in its market relative to competitors. Leveraging the target-audience profile and company overview, the constructor produces long-form and short-form variants highlighting differentiation, e.g., that the product is an AI-powered framework eliminating messaging guesswork and enabling superior client growth. The positioning statement becomes a semantic anchor used by downstream modules—particularly brand promise and tagline generation—to preserve consistent market framing across all communications.

System 100's value-proposition generator synthesizes functional and emotional benefits into declarative customer value statements. By correlating prior modules'data, the system can output language such as “AI-guided frameworks that eliminate guesswork and deliver measurable client growth.” Each generated proposition is linked to quantifiable metrics such as speed-to-launch or conversion rate, enabling evaluation and A/B testing of message performance. The module thus converts qualitative marketing claims into machine-interpretable data used by an optimization routine of system 100.

A brand-promise modeling component encodes the fundamental commitment that the brand delivers to its users. System 100 may generate promises emphasizing confidence, precision, and growth—e.g., “gain confidence to craft high-converting messages without guesswork.” Through reinforcement learning, the system can evaluate which phrasing yields the highest engagement scores and dynamically refine subsequent messaging to align with the proven promise language.

A benefits expander module in system 100 can generate brand promise benefits that articulates tangible outcomes derived from the brand promise. Example outputs include statements that the structured AI framework makes message creation ninety percent faster, validates pre-launch content, and ensures superior client growth. These benefits are parameterized for quantification, allowing performance tracking and automatic inclusion of empirical metrics in generated materials.

System 100 establishes a group of brand pillars representing core functional values. In representative embodiments, these pillars include: (1) AI-Powered Messaging, emphasizing automation and precision; (2) Precision Word Crafting, emphasizing linguistic optimization; and (3) Accelerated Client Growth, emphasizing time efficiency and ROI. The system links each pillar to supporting text and metadata, ensuring that all derivative copy reinforces these foundational themes.

An associated benefit-mapping routine elaborates on each pillar's direct advantages. For AI-powered messaging, system 100 may describe transforming user ideas into conversion-focused output; for Precision Word Crafting, refinement of phrasing to maximize audience resonance; and for Accelerated Client Growth, faster campaign execution with demonstrably improved results. These benefits are weighted for prominence according to context, enabling adaptive emphasis across different communication channels.

System 100 further identifies core differentiators, distinguishing the user's brand from generic tools. Examples include a guided-messaging flow that provides a step-by-step creation sequence and a marketer-confidence feature that transforms stress into assurance. The system records these differentiators as structured attributes for reuse in taglines, pitches, and automated comparisons, reinforcing competitive advantage throughout generated output.

A value-benefits analyzer within system 100 enumerates operational outcomes such as messaging confidence, client growth, conversion maximization, workflow efficiency, and professional satisfaction. The system uses analytics feedback to rank these benefits by measured impact, allowing subsequent AI modules to highlight the most persuasive advantages during content generation or presentation assembly.

System 100 includes a tagline-generation engine employing linguistic modeling to produce concise, emotionally resonant statements derived from the brand promise, pillars, and positioning data. The system may output both customer-centric and product-centric variants, such as “Peace of mind, word by precise word,” “The framework for fearless words,” or “AI-guided precision. Proven conversions.” Each tagline is algorithmically scored for clarity, emotional appeal, and alignment with the brand persona before presentation to the user for selection or refinement.

Finally, system 100 implements a headline-construction module that generates short, high-impact statements suitable for marketing materials, web pages, or presentations. Drawing on trained corpora of persuasive syntax, the module produces examples such as “Stop guessing. Craft client-winning words with AI precision,” or “Escape messaging overwhelm. Grow clients, gain peace of mind.” Each candidate headline is evaluated on semantic focus, tone alignment, and expected engagement probability, allowing system 100 to recommend or automatically deploy the highest-performing options.

In some aspects, the process 400 can include creating, based on the messaging framework 124, one or more assets, including an email, a website landing page, and a social media post. The process 400 can include storing and refining inputs, tone preferences, and past messaging frameworks to obtain stored historical data; and building a business-specific artificial intelligence model, based on the stored historical data, to generate further messaging frameworks. The business-specific artificial intelligence model can be generated also based on some other artificial intelligence model as well. In some aspects, the process 400 can include generating, pre-market, and via a probability model, a resonance score related to pre-market validation of the messaging framework 124. The resonance score can be generated from a probability model built on one or more of a campaign goal, an industry context, a target audience profile, a desired emotional response, an intended action, and a delivery channel. For example, the delivery channel can be one or more of an email channel, a social media channel, a web channel, an application channel, or a texting channel. The resonance score can be associated with the probability of success in the messaging framework 124, which can include data from multiple artificial intelligence models.

Further, the messaging framework 124 can include multiple messaging frameworks. There can be various versions of the messaging framework 124. In such a case, the process 400 can further include presenting the multiple messaging frameworks to the user, and receiving a selection of a chosen messaging framework of the multiple messaging frameworks.

The process 400 can include one or more optional additional steps, including one or more of: obtaining competitor data by monitoring competitor marketing activities; adding the competitor data to the business data in the sphere to obtain updated business data; performing context-aware retrieval, via use of the updated business data, by the artificial intelligence model; receiving a selection, from a library of brains, of a brain for guiding the artificial intelligence model regarding a prompt framework and messaging framework 124 generation specific to a vertical or style associated with the brain; interacting with the user via marketing-brain-enhanced prompts from the artificial intelligence model; and generating the messaging framework 124 based on feedback from user to the marketing-brain-enhanced prompts. The messaging framework 124 can be on-brand and context-specific.

The library of brains can include modular “brains” like a pharma brain, a Taylor Swift brain, etc. In some aspects, the processes described above can be done by agents that, when the user specifies competitors, perform a competitive analysis report at the beginning of the process when the client is created.

In some aspects, a system for generating a message framework includes at least one processor; and a computer-readable medium storing instructions, which, when executed by the at least one processor, cause the at least one processor to be configured to: receive a set of documents, from a user, wherein the set of documents relates to a business; activate, based on the set of documents, a brand intelligence layer that processes and embeds business data related to the set of documents for the business to generate a sphere associated with the business and to enable the business data to be available for context-aware retrieval by an artificial intelligence model; generate, based on the set of documents and the sphere, a project brief; access, by the artificial intelligence model, the sphere for context; transmit the project brief to the artificial intelligence model; and generate, based on the project brief, the context and via the artificial intelligence model, a messaging framework 124, wherein the artificial intelligence model is trained on go-to-market strategies, messaging architectures, and real-world marketing nuance data.

In some aspects, a computer-readable medium stores instructions, which, when executed by at least one processor, cause the at least one processor to be configured to: receive a set of documents, from a user, wherein the set of documents relates to a business; activate, based on the set of documents, a brand intelligence layer that processes and embeds business data related to the set of documents for the business to generate a sphere associated with the business and to enable the business data to be available for context-aware retrieval by an artificial intelligence model; generate, based on the set of documents and the sphere, a project brief; access, by the artificial intelligence model, the sphere for context; transmit the project brief to the artificial intelligence model; and generate, based on the project brief, the context and via the artificial intelligence model, a messaging framework 124, wherein the artificial intelligence model is trained on go-to-market strategies, messaging architectures, and real-world marketing nuance data.

In some aspects, the processes described herein (e.g., process 300, process 400 and/or other process described herein) may be performed by a computing device or apparatus or a component or system (e.g., a chipset, one or more processors (e.g., central processing unit (CPU), graphics processing unit (GPU), neural processing unit (NPU), digital signal processor (DSP), etc.), ML system such as a neural network model, etc.) of the computing device or apparatus. The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device. In some cases, the computing device or apparatus can be the computing system 700 of FIG. 7, a vehicle, and/or other computing device or apparatus.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 300, process 400 and/or other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some aspects, the computing device may include a display, a network interface configured to communicate and/or receive the data, any combination thereof, and/or other component(s). The network interface may be configured to communicate and/or receive Internet Protocol (IP) based data or other types of data.

The components of the computing device can be implemented in circuitry. In some aspects, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

Process 300 and process 400 are illustrated as logical flow diagrams, which represent a sequence of operations that can be implemented in hardware, computer instructions, or a combination thereof. In computer instructions, the operations represent computer-executable instructions stored on one or more computer-readable storage media that perform the recited operations when executed by one or more processors. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 300 and process 400, method and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in a computer program including a plurality of instructions executable by one or more processors. The computer-readable or machine-readable storage medium may be non-transitory.

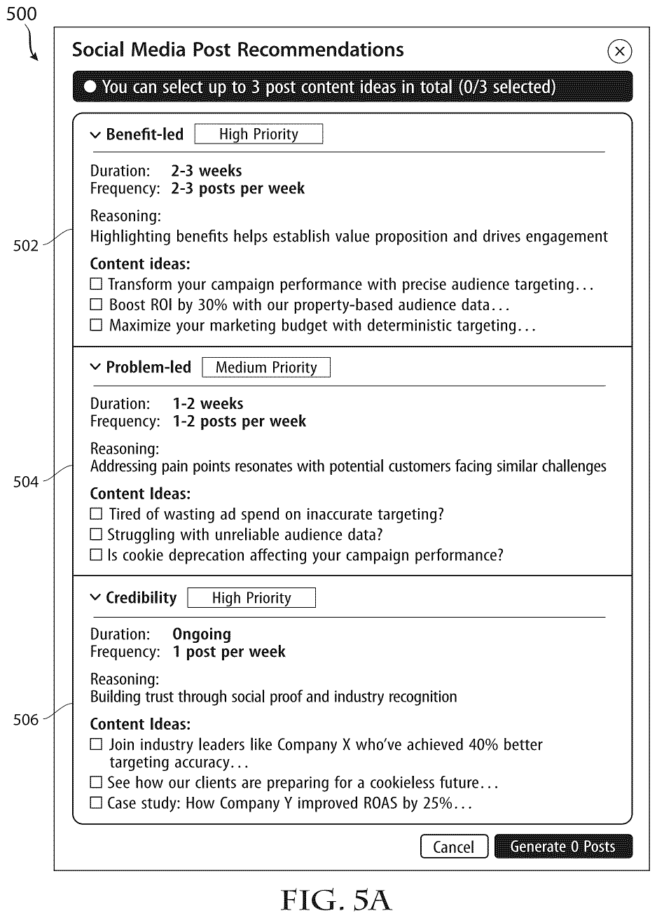

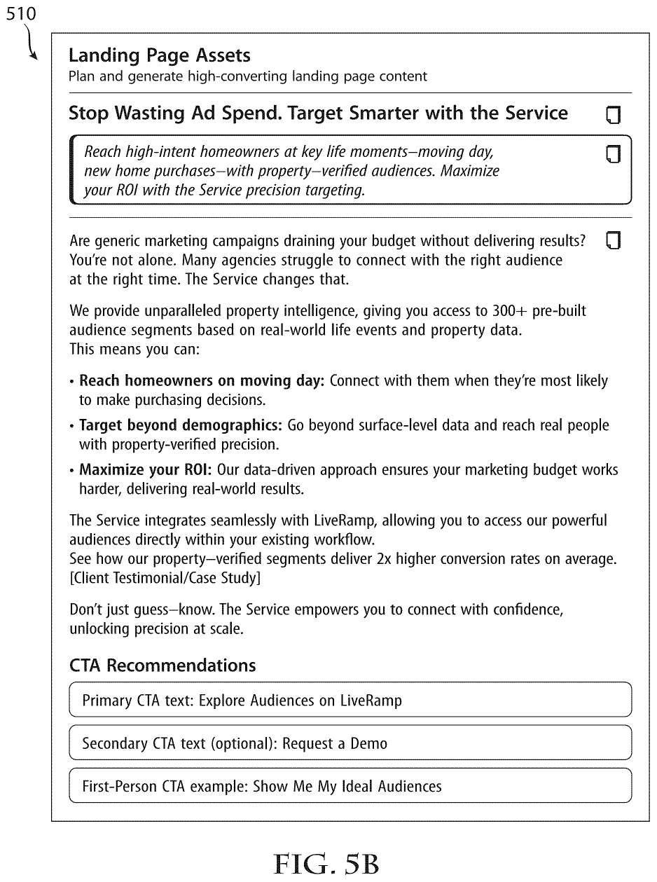

FIG. 5A illustrates a post recommendation user interface 500, which can be used for generating social media posts (e.g., LinkedIn, X, or Instagram). UI components: prompt input, AI-suggested posts, “Regenerate” and “Copy Output” buttons, “Add Custom Content Idea,” and preview pane. A first panel 502 can represent options for duration, frequency, and content ideas for posts on any platform, such as LinkedIn, that are benefits-led. The user can select the content ideas for the campaign.

A second panel 504 represents establishing a problem-led campaign with a direction and frequency selection for posting on the platform. Content ideas such as waiting time, struggling with unreliable data or cookie deprecation can be selected by the user. A third panel, 506, represents the control of a credibility campaign with other durations, frequencies, and content idea selection. The user interface enables a user to select or tailor a posting campaign on a platform such as LinkedIn or another platform.

FIG. 5B illustrates a landing page 510 with various information about generating email or messaging content. The landing page 510 represents an example user interface with components such as a subject line generator, a body generator, selectable tone and call-to-action (CTA) fields, and a ranked list of AI-suggested email drafts.

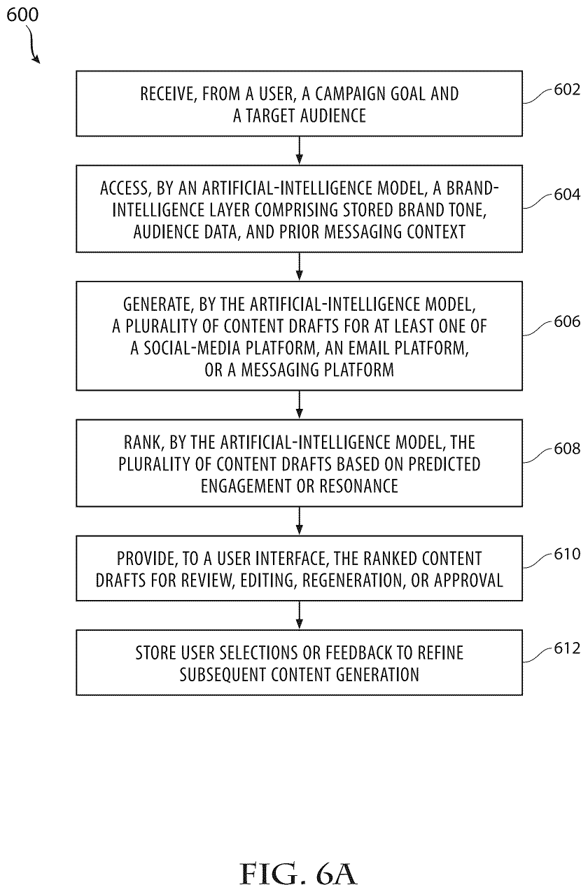

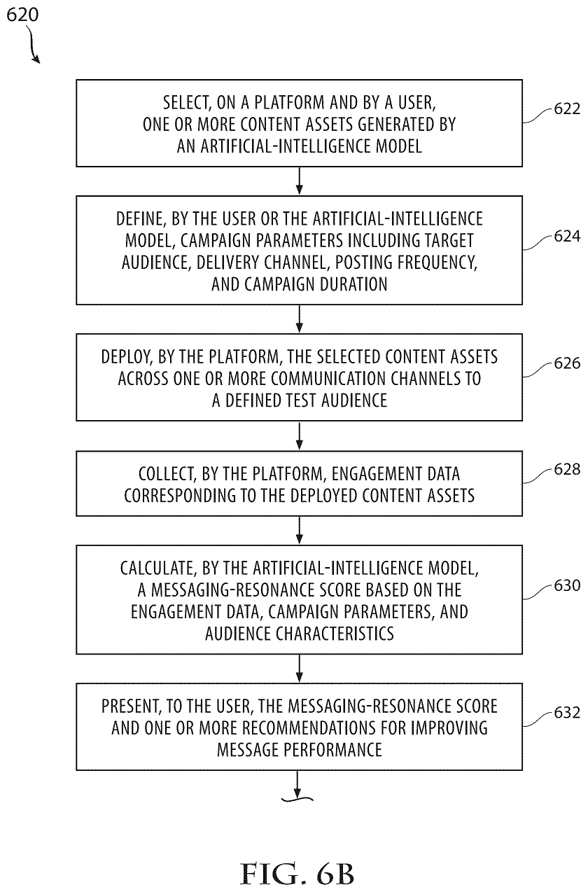

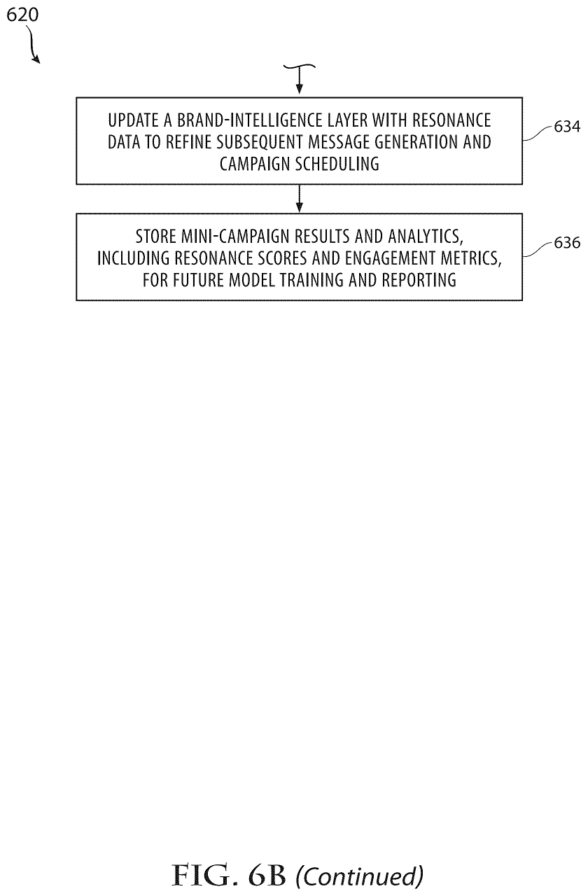

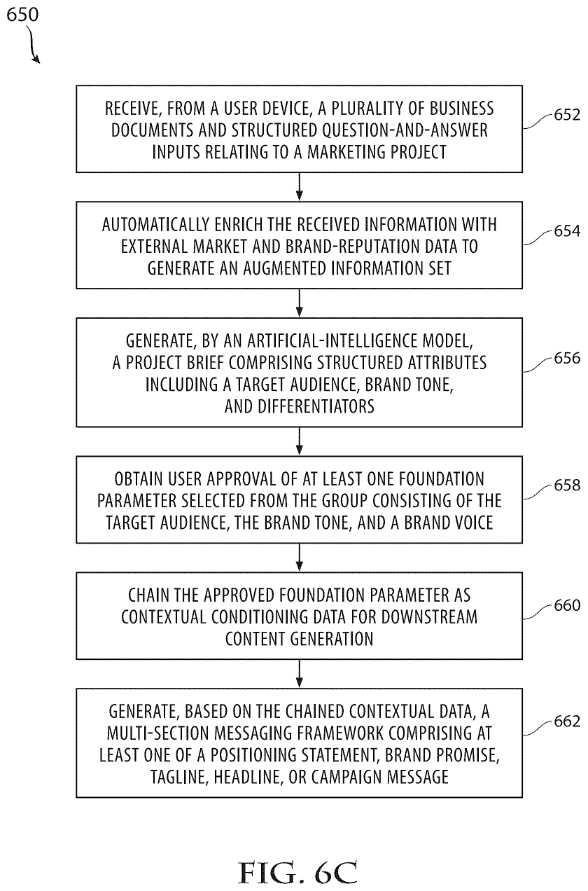

FIG. 6A illustrates an example of a process 600 for generating social media and messaging content using an artificial intelligence-powered marketing platform, according to aspects of the disclosure. The process 600 can be performed by an apparatus such as one or more of the system 100, a user device 105, an artificial intelligence (AI) model 108, a computing device 700, a computer processor such as processor 710, and/or any subcomponents thereof.

At block 602, the method 600 causes a system to be configured to receive, from a user, a campaign goal and a target audience. The campaign goal can include one or more objectives such as increasing engagement, driving conversions, announcing a product release, or testing a brand message. The target audience can include user-defined parameters such as demographics, geographic region, industry, interests, or professional level.

At block 604, the method 600 causes the system to access, by an artificial intelligence model, a brand intelligence layer including stored brand tone, audience data, and prior messaging context. The brand intelligence layer may correspond to a sphere or persistent workspace that stores accumulated brand data, tone selections, and historical campaign outcomes. The stored data provides context for generating content consistent with the brand's prior messaging style and tone.

At block 606, the method 600 causes the system to generate, by the artificial intelligence model, a plurality of content drafts for one or more digital channels, including at least one of a social media platform, an email platform, or a messaging platform. The content drafts may include individual posts, captions, subject lines, or message bodies corresponding to different tone variants, emotional appeals, or stylistic forms. In some aspects, each draft may include a corresponding call-to-action (CTA) automatically generated by the AI model and tailored to the campaign goal and target audience. The CTA may include prompts such as “Learn More,” “Register Now,” or “Schedule a Demo,” dynamically selected based on platform and message type.

At block 608, the method 600 causes the system to rank, by the artificial intelligence model, the plurality of content drafts based on predicted engagement or resonance. The ranking can be performed using a probabilistic resonance model trained on engagement metrics, message tone, campaign objectives, and target audience parameters. The resonance model can compute a predicted engagement score for each draft, representing a likelihood of audience interaction such as clicks, opens, or conversions.

At block 610, the method 600 causes the system to provide the ranked content drafts to a user interface for review, editing, regeneration, or approval. The user interface may display a list or card-based layout showing each draft's predicted resonance score, platform designation, and CTA. Users may regenerate one or more drafts, modify tone or structure, or add custom text. The platform may also enable the user to select an approval option for one or more drafts and export them to connected systems such as posting tools, email marketing platforms, or direct messaging services.

At block 612, the method 600 causes the system to store user selections, feedback, and approval data to refine subsequent messaging generation. The stored data can include accepted drafts, edits made by the user, and timing of posting preferences. This feedback loop enables fine-tuning of the AI model through continuous learning. In some aspects, the platform may automatically recommend or determine optimal posting frequency and duration based on historical engagement performance. For instance, the system may schedule content for daily or weekly publication or determine a campaign period (e.g., seven days, one month) for repeated or staggered posting. The AI model can dynamically adjust the posting frequency and duration to align with audience activity patterns, time-zone analytics, and prior performance.

In some implementations, the platform may further determine optimal time-of-day windows for posting content on specific platforms based on historical engagement metrics and platform algorithms. The system may also predict when a message will have diminished performance and adjust the cadence or tone accordingly.

In various aspects, the AI model may generate multiple tone variants for the same campaign goal, each variant corresponding to a distinct brand personality or communication style, such as “formal and professional,” “approachable and friendly,” or “insightful and witty.” Each tone variant may be evaluated using the resonance model to identify the highest-performing messaging strategy.

In some aspects, a system for generating social and messaging content can include one or more processors and one or more non-transitory computer-readable media storing instructions that, when executed by the one or more processors, cause the system to perform operations corresponding to the process 600. The one or more processors can be configured to: execute instructions to receive, from a user device, a campaign goal and target audience (corresponding to block 602); access, via a network interface, a brand intelligence layer stored in memory containing audience profiles, tone parameters, and historical message data (corresponding to block 604); generate, using an artificial intelligence model, a plurality of social media or messaging content drafts that include tone variants and customized call-to-action (CTA) text (corresponding to block 606); rank the plurality of content drafts according to predicted engagement metrics using a probabilistic resonance scoring engine (corresponding to block 608); display the ranked drafts within a user interface to enable review, editing, regeneration, and approval, and to enable scheduling of posts or emails at determined intervals (corresponding to block 610); and store the user feedback, approval data, and scheduling selections to refine future model outputs and dynamically adjust posting duration and frequency (corresponding to block 612).

In some embodiments, the system further includes a scheduler module configured to determine an optimal cadence and posting duration for each approved draft based on audience engagement predictions. The system may communicate with third-party services such as LinkedIn®, X (formerly Twitter®), email marketing platforms, or messaging applications to publish approved content automatically according to the optimized schedule.

In some aspects, a computer-readable medium stores instructions, which, when executed by at least one processor, cause the at least one processor to perform operations corresponding to the process 600 described with reference to FIG. 6A.

The one or more processors may execute instructions to: receive, from a user device, a campaign goal and a target audience (corresponding to block 602); access, by an artificial intelligence model, a brand intelligence layer including stored brand tone, audience data, and prior messaging context (corresponding to block 604); generate, by the artificial intelligence model, a plurality of content drafts for at least one of a social media platform, an email platform, or a messaging platform (corresponding to block 606); rank, by the artificial intelligence model, the plurality of content drafts based on predicted engagement or resonance, wherein the ranking is determined using a probabilistic resonance model trained on engagement metrics, campaign objectives, and audience parameters (corresponding to block 608); provide, to a user interface, the ranked content drafts for review, editing, regeneration, or approval (corresponding to block 610); and store, in a non-volatile memory, user selections, feedback, approval data, and scheduling preferences to refine subsequent messaging generation (corresponding to block 612).

In some implementations, execution of the instructions further causes the at least one processor to: determine an optimal posting frequency or campaign duration based on historical engagement data, time-of-day performance, or audience activity patterns; generate and insert call-to-action (CTA) text tailored to the target audience and selected platform type; produce multiple tone variants for a given campaign goal, each corresponding to a distinct communication style, and rank those variants based on predicted resonance; and automatically export approved content to connected posting or messaging services according to a defined or AI-recommended schedule.

The computer-readable medium may include one or more of a magnetic disk, optical storage media, flash memory, solid-state storage, or any other non-transitory medium capable of storing executable instructions. The stored instructions, when executed, may configure the processor to perform one or more of the operations described herein to enable the generation, evaluation, and deployment of optimized social and messaging content through the marketing platform.

FIG. 6B illustrates an example of a process 620 for conducting a mini-campaign to test messaging effectiveness and determine a messaging resonance score, according to aspects of the disclosure. The process 620 can be performed by an apparatus such as one or more of the system 100, a user device 105, an artificial intelligence (AI) model 108, a computing device 700, a computer processor such as processor 710, and/or any subcomponents thereof. Data collected during mini-campaigns outlined in FIG. 6B may be automatically re-embedded into the sphere module 120 to fine-tune subsequent prompt weighting within the marketing brain.

At block 622, the method 620 causes a system to be configured to select, by a user, one or more content assets generated by the AI model. The content assets can include at least one social media post, email or message, and/or a landing-page layout. In some aspects, the system allows the user to choose among previously ranked or approved drafts (from FIG. 6A) and associate each with a campaign identifier.

At block 624, the method 620 causes the system to define campaign parameters, including target audience segments, campaign duration, posting frequency, and selected communication channels. The user may specify daily, weekly, or event-based delivery, while the system may recommend optimized cadence and active campaign duration based on prior engagement data. The parameters can also include a defined performance objective such as click-through rate, conversion rate, or awareness metric.

At block 626, the method 620 causes the system to deploy the selected content assets across multiple channels to a defined test audience. Deployment can occur through integrated social-media APIs, email-delivery platforms, or messaging services. Each asset is uniquely tracked with identifiers, allowing subsequent correlation between audience engagement data and content variant.

At block 628, the method 620 causes the system to collect campaign performance data, which may include impressions, views, reactions, link clicks, form submissions, or conversions. The system can automatically retrieve engagement metrics via connected APIs or embedded tracking pixels and store this data in a campaign analytics module.

At block 630, the method 620 causes the system to compute a messaging resonance score based on the collected performance data. A probabilistic model trained on campaign goal, audience profile, delivery channel, and tone parameters may generate the resonance score. In some aspects, the resonance score quantifies message effectiveness as a weighted probability of engagement success, thereby predicting which variant of messaging is most likely to perform well in broader deployment.

At block 632, the method 620 causes the system to generate recommendations or content adjustments derived from the resonance score and feedback data. The system can identify under-performing tone variants, ineffective calls-to-action (CTAs), or timing misalignments, and provide AI-generated revisions to improve resonance. The user may view such recommendations through a campaign-analysis dashboard and choose to regenerate or edit the affected assets.

At block 634, the method 620 causes the system to update the brand intelligence layer (sphere) with the resonance results and feedback. This update enables the AI model to refine its tone weighting, frequency recommendations, and CTA generation logic for subsequent campaigns. The resonance data becomes a long-term learning input to the predictive model underlying the marketing platform.

At block 636, the method 620 causes the system to store the mini-campaign results including resonance scores, engagement data, and campaign metadata-in persistent storage for future analysis and fine-tuning. The system may present an aggregated analytics view comparing multiple campaigns, channels, or time periods, allowing the marketer to evaluate brand consistency and messaging performance evolution over time.

In some aspects, a system for conducting mini-campaigns and determining messaging resonance includes one or more processors and one or more non-transitory computer-readable media storing instructions that, when executed by the one or more processors, cause the system to perform operations corresponding to the process 620. The one or more processors can be configured to: receive selections of content assets for testing, each linked to campaign goals and target audience data (corresponding to block 622); establish campaign parameters including frequency, duration, delivery channel, and performance metrics (corresponding to block 624); deploy the content assets across integrated social, email, and web platforms and assign unique tracking identifiers (corresponding to block 626); collect and aggregate engagement data from those channels into a unified analytics repository (corresponding to block 628); calculate a resonance score using a probabilistic or machine-learning model that evaluates success likelihood for each message variant (corresponding to block 630); generate and present recommendations to refine content tone, CTA, or scheduling parameters (corresponding to block 632); update a brand intelligence layer with resonance data to improve subsequent AI-generated messaging (corresponding to block 634); and store campaign analytics and resonance outcomes for reporting and further model training (corresponding to block 636).

In some implementations, the system may include a campaign-management interface enabling simultaneous testing of multiple mini-campaigns, each assigned a respective resonance score and performance summary. The system may communicate with external marketing automation tools to pause, extend, or replicate campaigns based on comparative resonance results.

In some aspects, a computer-readable medium stores instructions that, when executed by at least one processor, cause the at least one processor to perform operations corresponding to the process 620 described above. The one or more processors may execute instructions to: select campaign content assets generated by an artificial-intelligence model (block 622); define campaign parameters including frequency, duration, and delivery channel (block 624); deploy the selected content to a defined audience via connected posting and messaging services (block 626); collect engagement and performance data from the deployed channels (block 628); compute a resonance score using a machine-learning model that evaluates message effectiveness (block 630); produce AI-generated recommendations for refining message tone, CTA, or posting schedule (block 632); update a brand intelligence layer with the resonance feedback to inform subsequent message generation (block 634); and store the campaign results and analytics in non-volatile memory for reporting and iterative model training (block 636).

Execution of the instructions may further cause the processor to automatically adjust campaign duration or posting cadence based on engagement trends detected during live deployment. The computer-readable medium may include any non-transitory storage device, such as magnetic, optical, or solid-state memory, configured to retain the instructions that enable computation, analysis, and adaptation of messaging resonance within the marketing platform.

FIG. 6C illustrates an example of a process 650 of creating a client project, generating a project brief and generating a messaging framework 124 which can be distributed through a communication output such as LinkedIn or an email platform, according to aspects of the disclosure. The process 650 can be performed by an apparatus such as one or more of the system 100, a user device 105, an artificial intelligence (AI) model 108, a computing device 700, a computer processor such as processor 710, and/or any subcomponents thereof. FIG. 6C illustrates an example process 650 executed by the platform to generate an enriched project brief and multi-section messaging framework using chained contextual conditioning data.

At block 652, the system is configured to receive, from a user device, a plurality of business documents and structured question-and-answer inputs relating to a marketing project. The received materials may include brand guidelines, pitch decks, campaign briefs, voice-of-customer transcripts, and answers collected through an on-screen guided-question interface. These materials form the project's foundational dataset, capturing structured and unstructured information relevant to a specific client or campaign. The received data are parsed, normalized, and stored in association with a hierarchical record structure in which each client may be linked to one or more projects.

At block 654, the system is configured to automatically enrich the received materials with external market and brand-reputation data to generate an augmented information set. In this stage, background agents or data connectors access external information sources—such as market-trend databases, sentiment analyses, competitive reports, and reputation metrics—and merge the results into the existing project dataset. The augmented set provides contextual grounding for subsequent artificial-intelligence operations, ensuring that the system's inferences and generated content reflect current market conditions and brand positioning.

At block 656, the system is configured to generate, by an artificial-intelligence model, a project brief that includes structured attributes, including a target audience, brand tone, differentiators, and other core descriptors. The model analyzes the augmented information set, segments the content into topical groupings, and summarizes each into structured insight fields of the brief. A prompt-assistance interface may dynamically offer example phrasing or prompt refinements to help the user edit or regenerate sections of the brief until a consistent, semantically aligned version is achieved.

In some aspects, write-with-AI assistant dynamically suggests phrasing or prompt modifications to guide the user through crafting improved copy.

At block 658, the system is configured to obtain user approval of at least one foundation parameter, such as the target audience, the brand tone, or the brand voice. Once approval is received, the system records an immutable foundation state representing the confirmed brand identity for the project. Future modifications to the approved parameters trigger controlled regeneration of dependent sections, maintaining coherent propagation of tone and messaging alignment across all downstream outputs.

At block 660, the system is configured to chain the approved foundation parameters as contextual conditioning data for subsequent content generation. These parameters act as persistent constraints embedded within the model's prompt architecture, guiding the creation of all later materials. By chaining the foundation data, the system ensures that every generated element—whether narrative, tagline, or campaign-level asset—remains consistent with the validated tone, audience, and brand identity.

At block 662, the system is configured to generate, based on the chained contextual data, a multi-section messaging framework that includes one or more of a positioning statement, brand promise, tagline, headline, or campaign message. Each section can be reviewed, refined, or regenerated independently or collectively. Framework elements may be categorized as core messaging components or creative assets, enabling separate export, white-label delivery, or integration with third-party campaign-deployment tools. The system may also compute predictive resonance scores representing expected performance of the generated messaging, which are stored for use in future refinement cycles.

In some aspects, the system can also generate brand identity modules, such as brand pillars and support points, that complement core messaging in the messaging framework 124. Go-to-Market assets such as social-media posts, emails, and landing-page copy for a website or application may be automatically generated and exported via the communication platform. Additional embodiments can include client-feedback modules, section locking, and scheduling tools for coordinated review.

In a corresponding system embodiment, one or more processors and memory components are configured to execute operations that include: receiving, from a user device, a plurality of business documents and structured question-and-answer inputs relating to a marketing project; automatically enriching the received information with external market and brand-reputation data to generate an augmented information set; generating, by an artificial-intelligence model, a project brief including structured attributes such as a target audience, brand tone, and differentiators; obtaining user approval of at least one foundation parameter selected from the target audience, brand tone, or brand voice; chaining the approved foundation parameter as contextual conditioning data for downstream content generation; and generating, based on the chained contextual data, a multi-section messaging framework including one or more of a positioning statement, brand promise, tagline, headline, or campaign message. The system further includes user-interface layers for guided input and review, storage modules maintaining version-controlled records, and optional connectors to external data sources and publishing platforms.

In a corresponding computer-readable-medium embodiment, a non-transitory medium stores instructions that, when executed by one or more processors, cause the processors to perform steps including: receiving, from a user device, business documents and structured question-and-answer inputs for a marketing project; enriching the received information with external market and reputation data to form an augmented information set; generating, by an artificial-intelligence model, a project brief with structured attributes including a target audience, brand tone, and differentiators; obtaining user approval of a foundation parameter; chaining the approved foundation parameter as contextual data for subsequent content generation; and generating, based on the chained contextual data, a multi-section messaging framework including at least one of a positioning statement, brand promise, tagline, headline, or campaign message, for review, refinement, and export as client-ready deliverables.

Some aspects of this disclosure are drawn from the priority provisional patent application. One can reference the provisional patent application, incorporated herein by reference, for figures and other details. The concepts in the priority patent application focused on the need for a platform to be provided that enables marketers to develop impactful messaging more efficiently. Marketers who have access to such a platform can deliver strategic value within budget and more quickly. The platform disclosed in the priority patent application gathers necessary information and generates data packages for submission to an artificial intelligence model to generate a messaging framework. The platform includes additional features such as the ability of a user to edit one section or portion of a messaging framework and then rerun a query to the artificial intelligence model just on the edited section and not the entire messaging framework.

The platform can be used to evaluate the messaging framework as well for a probability of plagiarism with messaging or data from other companies. The request to check for plagiarism can be for the whole messaging framework or on a section-by-section basis. The artificial intelligence model can generate a plagiarism score that quantifies the probability of plagiarism for individual phrases, the full messaging framework, or any portion of it.

The platform can enable users to interact with the artificial intelligence model while filling out a questionnaire to obtain summaries of individual questions and answers as part of gathering data to generate a data package to submit to the artificial intelligence model to generate the entire messaging framework.

The platform can regenerate individual sections of the messaging framework and enable the user to easily input additional instructions for the regeneration step, rather than having to generate a data package to be sent to the artificial intelligence model that includes the entire messaging framework. The disclosed innovations relate to a front-end platform for an artificial intelligence model that provides a user interface and selectable options to take data associated with a company and generate a data package to submit to the artificial intelligence model, including data and instructions to generate a messaging framework. The front-end platform can then present a structure and user interface that enables a user to edit and revise the messaging framework and regenerate individual sections via additional interactions with the artificial intelligence model, as well as check for plagiarism via separate interactions with the artificial intelligence model.

The front-end platform introduces a technical solution to the problems outlined above and simplifies the user experience and enables the user to interact in numerous different ways with the artificial intelligence model to generate individual summaries of sections at one phase of the process, generate individual or framework-wide plagiarism scores, generate the entire messaging framework, or regenerate just a portion of the messaging framework with the option to add specific new instructions for the regeneration step.

In some aspects, the techniques described relate to an apparatus for generating a message framework, the apparatus including: at least one processor; and a computer-readable medium storing instructions, which, when executed by the at least one processor, cause the at least one processor to be configured to: receive, via a user interface, a request to create a new messaging project; receive project details and project goals associated with the new messaging project; generate an artificial intelligence package includes the project details, project goals and instructions to an artificial intelligence model, the instructions including at least one or more of: (1) a request to generate a summary associated with the new messaging project, (2) a request to generate a draft of the messaging framework, (3) a request to generate a plagiarism check associated with the new messaging project, and (4) a request to modify/regenerate an object or section in the draft of the messaging framework; submit the artificial intelligence package to the artificial intelligence model, wherein the artificial intelligence model generates the draft of the messaging framework, wherein the draft of the messaging framework includes a plurality of sections and each section of the plurality of sections includes a respective result; receive the draft of the messaging framework from the artificial intelligence model; present, via a project dashboard of the user interface, the draft of the messaging framework, the project dashboard enabling a user to view the respective result in each section of the plurality of sections and to perform operations on the respective result; and receive, from the user and via the project dashboard, an edit of the respective result to generate an edited version of the messaging framework.

In some aspects, the techniques described herein relate to a method for generating a message framework, the method including: receiving, via a user interface, a request to create a new messaging project; receiving project details and project goals associated with the new messaging project; generating an artificial intelligence package includes the project details, project goals and instructions to an artificial intelligence model, the instructions including at least one or more of: (1) a request to generate a summary associated with the new messaging project, (2) a request to generate a draft of the messaging framework, (3) a request to generate a plagiarism check associated with the new messaging project and (4) a request to modify/regenerate an object or section in the draft of the messaging framework; submitting the artificial intelligence package to the artificial intelligence model, wherein the artificial intelligence model generates the draft of the messaging framework, wherein the draft of the messaging framework includes a plurality of sections and each section of the plurality of sections includes a respective result; receiving the draft of the messaging framework from the artificial intelligence model; presenting, via a project dashboard of the user interface, the draft of the messaging framework, the project dashboard enabling a user to view the respective result in each section of the plurality of sections and to perform operations on the respective result; and receiving, from the user and via the project dashboard, an edit of the respective result to generate an edited version messaging framework.

In some aspects, the processes described in the priority provisional patent application (e.g., process 800 and/or other process described therein) may be performed by a computing device or apparatus or a component or system (e.g., a chipset, one or more processors (e.g., CPU, GPU, NPU, DSP, etc.), ML system such as a neural network model, etc.) of the computing device or apparatus. In some aspects, one or more of the apparatuses described herein is, is part of, and/or includes any kind of apparatus such as an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus further includes a display for displaying one or more user interfaces, images, notifications, and/or other displayable data.

FIG. 7 is a diagram illustrating a system for implementing certain aspects of the present technology. In particular, FIG. 7 illustrates a computing system 700, which can be any computing device making up internal computing system, a remote computing system, a camera, or any component thereof in which the components of the system are in communication with each other using connection 707. Connection 705 can be a physical connection using a bus, or a direct connection into processor 710, such as in a chipset architecture. Connection 705 can also be a virtual connection, networked connection, or logical connection.

In some aspects, computing system 700 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

The system 700 includes at least one processing unit (CPU or processor) such as processor 710 and connection 705 that couples various system components including system memory 715, such as read-only memory (ROM) 720 and random-access memory (RAM) 725 to processor 710. Computing system 700 can include a cache 712 of high-speed memory connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms. In some instances, multimodal systems can enable a user to provide multiple types of input/output to communicate with computing system 700. Computing system 700 can include communications interface 740, which can generally govern and manage the user input and system output. The communications interface 740 may also include one or more receives for use in location-based data. The communications interface 740 can also include the infrastructure to communicate other types of data as well.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 710, the code causes the system to perform a function. In some aspects, a hardware service that performs a particular function can include the software component stored in a computer-readable medium in connection with the necessary hardware components, such as processor 710, connection 705, output device 735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. In some aspects, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, in some aspects, instructions and data which cause or otherwise configure a general-purpose computer, special purpose computer, or a processing device to perform a certain function or group of functions. Portions of computer resources used can be accessible over a network. The computer executable instructions may be, in some aspects, binaries, intermediate format instructions such as assembly language, firmware, source code. Examples of computer-readable media that may be used to store instructions, information used, and/or information created during methods according to described approaches include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, according to some aspects.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, in some aspects, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. In some aspects, claim language reciting “at least one of A and B” or “at least one of A or B” means A, B, or A and B. In some aspects, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. In some aspects, claim language reciting “at least one of A and B” or “at least one of A or B” can mean A, B, or A and B, and can additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the aspects disclosed herein may be implemented as electronic hardware, computer software, firmware, or combinations thereof. To clearly illustrate the interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules, engines, or components may be implemented together in an integrated logic device or separately as discrete but interoperable logic devices. If implemented in software, then the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative clauses of the disclosure include:

### Clause Set I: Generating Marketing Content

Clause 1. A method for generating marketing content using an artificial intelligence-powered platform, the method comprising: uploading a set of business documents, each tagged by type, into a platform; parsing and segmenting the set of business documents into content chunks; analyzing the content chunks using a large language model to generate insights; organizing the insights into a structured project brief; approving a target audience and brand tone to obtain an approved audience and tone, which are chained to all downstream outputs; generating, by the platform, a marketing messaging framework aligned with the approved audience and tone using enhanced prompts; and evaluating the marketing messaging framework using a scoring mechanism to predict messaging success.
Clause 2. The method of any clause 1, wherein the set of business documents includes one or more of pitch decks, brand guidelines, and customer interviews.
Clause 3. The method of any previous clause, wherein the content chunks are prepared for analysis by a user-selectable large language model.
Clause 4. The method of any previous clause, further comprising: allowing marketers to review and edit the structured project brief before a final messaging framework is generated.
Clause 5. The method of any previous clause, wherein the scoring mechanism provides a probability of messaging success and allows for A/B testing and better messaging selection.
Clause 6. The method of any previous clause, further comprising: continuously monitoring an external market using a sphere component to automatically update messaging or provide recommendations when relevant events occur.
Clause 7. The method of any previous clause, wherein the platform comprises a library of brains for various industries, allowing users to select a respective brain to guide a prompt framework and provide insights specific to a vertical or marketing style.
Clause 8. The method of any previous clause, wherein the structured project brief comprises fields such as one or more of an audience field, a differentiator field, a positioning field, and a brand tone.
Clause 9. The method of any previous clause, wherein the enhanced prompts are generated using a marketing brain comprising a custom, pre-trained artificial intelligence prompt enhancer.
Clause 10. The method of any previous clause, further comprising: integrating feedback from multiple large language models to enhance insight generation.
Clause 11. An apparatus for generating a message framework, the apparatus comprising: at least one processor; and a computer-readable medium storing instructions, which, when executed by the at least one processor, cause the at least one processor to be configured to: upload a set of business documents, each tagged by type, into a platform; parse and segment the set of business documents into content chunks; analyze the content chunks using a large language model to generate insights; organize the insights into a structured project brief; approve a target audience and brand tone to obtain an approved audience and tone, which are chained to all downstream outputs; generate, by the platform, a marketing messaging framework aligned with the approved audience and tone using enhanced prompts; and evaluate the marketing messaging framework using a scoring mechanism to predict messaging success.
Clause 12. The apparatus of clause 11, wherein the set of business documents includes one or more of pitch decks, brand guidelines, and customer interviews.
Clause 13. The apparatus of any of clauses 11-12, wherein the content chunks are prepared for analysis by a user-selectable large language model.
Clause 14. The apparatus of any of clauses 11-13, wherein the at least one processor to be configured to: allow marketers to review and edit the structured project brief before a final messaging framework is generated.
Clause 15. The apparatus of any of clauses 11-14, wherein the scoring mechanism provides a probability of messaging success and allows for A/B testing and better messaging selection.
Clause 16. The apparatus of any of clauses 11-15, wherein the at least one processor to be configured to: continuously monitor an external market using a sphere component to automatically update messaging or provide recommendations when relevant events occur.
Clause 17. The apparatus of any of clauses 11-16, wherein the platform comprises a library of brains for various industries, allowing users to select a respective brain to guide a prompt framework and provide insights specific to a vertical or marketing style.
Clause 18. The apparatus of any of clauses 11-17, wherein the structured project brief comprises fields such as one or more of an audience field, a differentiator field, a positioning field, and a brand tone.
Clause 19. The apparatus of any of clauses 11-18, wherein the enhanced prompts are generated using a marketing brain comprising a custom, pre-trained artificial intelligence prompt enhancer.
Clause 20. The apparatus of any of clauses 11-19, wherein the at least one processor to be configured to: integrate feedback from multiple large language models to enhance insight generation.
Clause 21. A computer-readable medium storing instructions, which, when executed by at least one processor, cause the at least one processor to be configured to: upload a set of business documents, each tagged by type, into a platform; parse and segment the set of business documents into content chunks; analyze the content chunks using a large language model to generate insights; organize the insights into a structured project brief; approve a target audience and brand tone to obtain an approved audience and tone, which are chained to all downstream outputs; generate, by the platform, a marketing messaging framework aligned with the approved audience and tone using enhanced prompts; and evaluate the marketing messaging framework using a scoring mechanism to predict messaging success.
Clause 22. The computer-readable medium of clause 21, wherein the set of business documents includes one or more of pitch decks, brand guidelines, and customer interviews.
Clause 23. The computer-readable medium of any of clauses 21-22, wherein the content chunks are prepared for analysis by a user-selectable large language model.
Clause 24. The computer-readable medium of any of clauses 21-23, wherein the at least one processor to be configured to: allow marketers to review and edit the structured project brief before a final messaging framework is generated.
Clause 25. The computer-readable medium of any of clauses 21-24, wherein the scoring mechanism provides a probability of messaging success and allows for A/B testing and better messaging selection.
Clause 26. The computer-readable medium of any of clauses 21-25, wherein the at least one processor to be configured to: continuously monitor an external market using a sphere component to automatically update messaging or provide recommendations when relevant events occur.
Clause 27. The computer-readable medium of any of clauses 21-26, wherein the platform comprises a library of brains for various industries, allowing users to select a respective brain to guide a prompt framework and provide insights specific to a vertical or marketing style.
Clause 28. The computer-readable medium of any of clauses 21-27, wherein the structured project brief comprises fields such as one or more of an audience field, a differentiator field, a positioning field, and a brand tone.
Clause 29. The computer-readable medium of any of clauses 21-28, wherein the enhanced prompts are generated using a marketing brain comprising a custom, pre-trained artificial intelligence prompt enhancer.
Clause 30. The computer-readable medium of any of clauses 21-29, wherein the at least one processor to be configured to: integrate feedback from multiple large language models to enhance insight generation.

### Clause Set II: Operating a Branding Messaging Pipeline

Clause 1. A method of operating a brand messaging artificial intelligence pipeline, the method comprising: receiving a set of documents, from a user, wherein the set of documents relates to a business; activating, based on the set of documents, a brand intelligence layer that processes and embeds business data related to the set of documents for the business to generate a sphere associated with the business and to enable the business data to be available for context-aware retrieval by an artificial intelligence model; generating, based on the set of documents and the sphere, a project brief; accessing, by the artificial intelligence model, the sphere for context; transmitting the project brief to the artificial intelligence model; and generating, based on the project brief, the context and via the artificial intelligence model, a messaging framework, wherein the artificial intelligence model is trained on go-to-market strategies, messaging architectures, and real-world marketing nuance data.
Clause 2. The method of clause 1, wherein the set of documents is editable and is configured to be provided downstream to an artificial intelligence marketing model.
Clause 3. The method of any of clauses 1-2, wherein the project brief comprises structured summaries of the set of documents and synthesizes one or more of a tone, an audience, positioning data and a market differentiator for the business.
Clause 4. The method of any of clauses 1-3, wherein the set of documents comprises one or more of client survey data, a sales pitch deck, brand guidelines, a video, an audio file, a voice of customer call transcripts, a scope of work, a project brief, a demonstration recording, and an internal call with an agency or marketing team.
Clause 5. The method of any of clauses 1-4, further comprising: receiving, with or without edits by the user, a confirmation of the project brief from the user prior to generating the messaging framework.
Clause 6. The method of any of clauses 1-5, wherein the business data comprises the set of documents and one or more of past messaging, inputs, frameworks and iterations of data such that the sphere comprises a persistent workspace that is accessed by the artificial intelligence model for the context when generating the messaging framework.
Clause 7. The method of any of clauses 1-6, wherein the set of documents comprises content in diverse file formats and wherein generating the project brief further comprises preprocessing the set of documents into text chunks.
Clause 8. The method of any of clauses 1-7, further comprising: presenting the project brief to the user for revision; and receiving revisions to the project brief before transmitting the project brief to the artificial intelligence model.
Clause 9. The method of any of clauses 1-8, further comprising: prior to generating the messaging framework: presenting, based on the project brief and from the artificial intelligence model, a brand tone and a target audience to the user based on the project brief; receiving one or more of edits to the brand tone or the target audience and a confirmation of the brand tone and the target audience; and updating, if relevant, prompts to the artificial intelligence model based on any edits to the brand tone or the target audience for generation of the messaging framework.
Clause 10. The method of any of clauses 1-9, wherein the messaging framework comprises a multi-section brand messaging framework.
Clause 11. The method of any of clauses 1-10, wherein the multi-section brand messaging framework comprises two or more sections chosen from a list consisting of: a target audience, a brand tone, a voice, a personality, a company category, a company description, an elevator pitch, a positioning statement, a brand statement, a brand promise, brand promise benefits, brand pillars, brand pillar benefits, core differentiators, value/benefit to target audience, a value/benefit description, taglines and headlines.
Clause 12. The method of any of clauses 1-11, wherein the artificial intelligence model comprises a selected artificial intelligence model selected from a group of artificial intelligence models in which each artificial intelligence model of the group of artificial intelligence models is trained on specific industries or styles for marketing purposes.
Clause 13. The method of any of clauses 1-12, further comprising: creating, based on the messaging framework, one or more asset comprising an email, a website landing page, and a social media post.
Clause 14. The method of any of clauses 1-13, further comprising: storing and refining inputs, tone preferences and past messaging frameworks to obtain stored historical data; and building a business-specific artificial intelligence model, based on one or more of the artificial intelligence model and the stored historical data and for generating further messaging frameworks.
Clause 15. The method of any of clauses 1-14, wherein the sphere is stored in a vector database and wherein the set of documents is transformed from unstructured brand-related inputs into the sphere.
Clause 16. The method of any of clauses 1-15, wherein the structured summaries in the project brief synthesizes key attributes including one or more of a target audience, a brand tone, a personality, one or more core differentiators, a positioning, a key messaging theme, an emotional driver, a company description, and a notable brand quote.
Clause 17. The method of any of clauses 1-6, wherein each field of a messaging framework is generated via a separate dedicated prompt to the artificial intelligence model.
Clause 18. The method of any of clauses 1-17, further comprising: generating, pre-market and via a probability model, a resonance score related to pre-market validation of the messaging framework.
Clause 19. The method of any of clauses 1-18, wherein the resonance score is generated from a probability model built on one or more of a campaign goal, an industry context, a target audience profile, a desired emotional response, an intended action and a delivery channel.
Clause 20. The method of any of clauses 1-19, wherein the delivery channel comprises one or more of an email channel, a social media channel, a web channel, an application channel and a texting channel.
Clause 21. The method of any of clauses 1-20, wherein the resonance score is associated with a probability of a success in the messaging framework.
Clause 22. The method of any of clauses 1-21, wherein the messaging framework comprises data from multiple different artificial intelligence models.
Clause 23. The method of any of clauses 1-22, wherein the messaging framework comprises multiple messaging frameworks, wherein the method further comprises: presenting the multiple messaging frameworks to the user; and receiving a selection of a chosen messaging framework of the multiple messaging frameworks.
Clause 24. The method of any of clauses 1-23, wherein the sphere comprises a target audience and one or more of a brand tone and a brand voice.
Clause 25. The method of any of clauses 1-24, wherein the sphere is chained to all downstream outputs to maintain consistency over the target audience, the brand tone or the brand voice.
Clause 26. The method of any of clauses 1-25, further comprising: obtaining competitor data by monitoring competitor marketing activities; adding the competitor data to the business data in the sphere to obtain updated business data; and performing context-aware retrieval, via use of the updated business data, by the artificial intelligence model.
Clause 27. The method of any of clauses 1-26, further comprising: receiving a selection, from a library of brains, of a brain for guiding the artificial intelligence model regarding a prompt framework and messaging framework generation specific to a vertical or style associated with the brain.
Clause 28. The method of any of clauses 1-27, further comprising: interacting with the user via marketing-brain-enhanced prompts from the artificial intelligence model; and generating the messaging framework based on feedback from the user to the marketing-brain-enhanced prompts, wherein the messaging framework is on-brand and context-specific.
Clause 29. The method of any of clauses 1-28, further comprising maintaining a hierarchical client-project structure, wherein each client account comprises a plurality of associated projects, each project defining a distinct messaging objective or campaign scope.
Clause 30. The method of any of clauses 1-29, wherein each client and project record includes respective metadata identifying one or more brand files, prior messaging frameworks, and performance metrics retrievable by the artificial-intelligence model for context-aware generation.
Clause 31. The method of any of clauses 1-30, further comprising enabling collaborative access by multiple users to a shared client or project workspace, wherein edits, approvals, and comments from different users are stored as session-linked collaboration data.
Clause 32. The method of any of clauses 1-31, wherein the shared workspace provides real-time synchronization of user comments, revisions, and approval states through an in-app messaging or chat interface.
Clause 33. The method of any of clauses 1-32, further comprising locking one or more sections of the messaging framework responsive to user approval or scheduling inputs to prevent further editing before client delivery.
Clause 34. The method of any of clauses 1-33, further comprising providing, through a user interface, an adaptive prompt-assistance module that dynamically suggests or modifies prompts to the artificial-intelligence model based on the user's edits, the approved brand tone, and prior outputs.
Clause 35. The method of any of clauses 1-34, wherein the adaptive prompt-assistance module analyzes semantic differences between user edits and model outputs to refine subsequent prompt parameters.
Clause 36. The method of any of clauses 1-35, wherein the platform aggregates user feedback and resonance scores across multiple clients to update prompt templates and weighting factors for the artificial-intelligence model.
Clause 37. The method of any of clauses 1-36, further comprising scheduling automatic regeneration of messaging frameworks at predetermined intervals or upon detection of external data updates in the sphere module.
Clause 38. The method of any of clauses 1-37, wherein regeneration events create versioned frameworks linked to their originating audience and tone approvals, enabling auditability and longitudinal comparison of messaging performance.
Clause 39. An apparatus for generating a message framework, the apparatus comprising: at least one processor; and a computer-readable medium storing instructions, which, when executed by the at least one processor, cause the at least one processor to be configured to: receive a set of documents, from a user, wherein the set of documents relates to a business; activate, based on the set of documents, a brand intelligence layer that processes and embeds business data related to the set of documents for the business to generate a sphere associated with the business and to enable the business data to be available for context-aware retrieval by an artificial intelligence model; generate, based on the set of documents and the sphere, a project brief; access, by the artificial intelligence model, the sphere for context; transmit the project brief to the artificial intelligence model; and generate, based on the project brief, the context and via the artificial intelligence model, a messaging framework, wherein the artificial intelligence model is trained on go-to-market strategies, messaging architectures, and real-world marketing nuance data.
Clause 41. An apparatus configured to perform any of the methods or operations of clauses 1-38.
Clause 42. A computer-readable medium stores instructions, which, when executed by at least one processor, cause the at least one processor to be configured to: receive a set of documents, from a user, wherein the set of documents relates to a business; activate, based on the set of documents, a brand intelligence layer that processes and embeds business data related to the set of documents for the business to generate a sphere associated with the business and to enable the business data to be available for context-aware retrieval by an artificial intelligence model; generate, based on the set of documents and the sphere, a project brief; access, by the artificial intelligence model, the sphere for context; transmit the project brief to the artificial intelligence model; and generate, based on the project brief, the context and via the artificial intelligence model, a messaging framework, wherein the artificial intelligence model is trained on go-to-market strategies, messaging architectures, and real-world marketing nuance data.
Clause 43. A computer-readable medium stores instructions, which, when executed by at least one processor, cause the at least one processor to be configured to perform any of the methods or operations of clauses 1-38.
Clause 44. A system for generating a messaging framework, the system comprising: a user device configured to receive, from a user, a set of documents relating to a business; a server or computing platform comprising: an artificial-intelligence (AI) model trained on go-to-market strategies, messaging architectures, and real-world marketing nuance data; a brand-intelligence layer configured to process and embed business data derived from the set of documents to generate a sphere associated with the business, the sphere comprising a persistent workspace that enables context-aware retrieval of the business data by the AI model; and a messaging-generation engine coupled to the AI model and the brand-intelligence layer and configured to: generate, based on the set of documents and the sphere, a project brief comprising structured summaries that synthesize one or more of a target audience, a brand tone, and a differentiator for the business; transmit the project brief to the AI model for contextual analysis; and generate, based on the project brief and the context provided by the sphere, a messaging framework aligned with the approved audience and tone; a resonance-scoring module configured to evaluate the messaging framework using a probabilistic or machine-learning model to predict messaging success; and a feedback module configured to update the sphere with resonance data and user-approval inputs to refine subsequent message generation.
Clause 45. A system configured to perform any of the methods or operations of clauses 1-38.

### Clause Set III: Generating Social Media and Messaging Content

Clause 1. A method for generating social media and messaging content using an artificial intelligence-powered marketing platform, the method comprising: receiving, at a messaging platform and from a user, a campaign goal and a target audience; accessing, by an artificial intelligence model, a brand intelligence layer comprising stored brand tone, audience data, and prior messaging context; generating, by the artificial intelligence model, a plurality of content drafts for at least one of a social media platform, an email platform, or a messaging platform; ranking, by the artificial intelligence model, the plurality of content drafts based on predicted engagement or resonance to obtain ranked content drafts; providing, to a user interface, the ranked content drafts for review, editing, regeneration, or approval; and storing user selections or feedback to refine subsequent messaging generation. Clause 2. The method of clause 1, wherein the plurality of content drafts comprise one or more of a LinkedIn post, a tweet, an Instagram caption, a social message, an email subject line, or an email body.
Clause 3. The method of any of clauses 1-2, wherein ranking the plurality of content drafts comprises applying a probabilistic resonance model trained on engagement metrics, message tone, campaign objectives, and target audience parameters.
Clause 4. The method of any of clauses 1-3, further comprising incorporating user feedback, edits, and approval history into a machine learning model to fine-tune future messaging generation.
Clause 5. The method of any of clauses 1-4, further comprising exporting, via the messaging platform, an approved content draft to an external posting system, an email delivery platform, or a messaging distribution service.
Clause 6. The method of any of clauses 1-5, further comprising scheduling, by the messaging platform, publication of approved content according to a frequency pattern defined by the user or recommended by the artificial intelligence model.
Clause 7. The method of any of clauses 1-6, wherein the frequency pattern comprises one or more of: a daily, weekly, or monthly posting schedule; a time-of-day optimization; or a cadence determined by historical audience engagement data.
Clause 8. The method of any of clauses 1-7, further comprising determining, by the artificial intelligence model, an optimal posting duration or campaign period for generated content based on platform analytics, target audience availability, or engagement forecasts.
Clause 9. The method of any of clauses 1-8, wherein the artificial intelligence model generates multiple tone variants for a same campaign goal, each variant corresponding to a distinct brand personality or communication style selected by the user.
Clause 10. The method of any of clauses 1-9, further comprising generating, by the messaging platform, call-to-action (CTA) recommendations tailored to the target audience and platform type, and incorporating a selected CTA into generated social or messaging content.
Clause 11. A system for generating social media and messaging content using an artificial intelligence-powered marketing platform, the system comprising: one or more processors; and one or more non-transitory computer-readable media storing instructions that, when executed by the one or more processors, cause the system to: receive, at a messaging platform and from a user, a campaign goal and a target audience; access, by an artificial intelligence model, a brand intelligence layer comprising stored brand tone, audience data, and prior messaging context; generate, by the artificial intelligence model, a plurality of content drafts for at least one of a social media platform, an email platform, or a messaging platform; rank, by the artificial intelligence model, the plurality of content drafts based on predicted engagement or resonance to obtain ranked content drafts; provide, to a user interface, the ranked content drafts for review, editing, regeneration, or approval; and store user selections or feedback to refine subsequent messaging generation.
Clause 12. The system of clause 11, wherein the plurality of content drafts comprise one or more of a LinkedIn post, a tweet, an Instagram caption, a social message, an email subject line, or an email body.
Clause 13. The system of any of clauses 1-12, wherein the one or more processors are configured to apply a probabilistic resonance model trained on engagement metrics, message tone, campaign objectives, and target audience parameters to rank the plurality of content drafts.
Clause 14. The system of any of clauses 1-13, wherein the one or more processors are further configured to incorporate user feedback, edits, and approval history into a machine learning model to fine-tune future messaging generation.
Clause 15. The system of any of clauses 1-14, wherein the one or more processors are further configured to export, via the messaging platform, an approved content draft to an external posting system, an email delivery platform, or a messaging distribution service.
Clause 16. The system of any of clauses 1-15, wherein the one or more processors are further configured to schedule publication of approved content according to a frequency pattern defined by the user or recommended by the artificial intelligence model.
Clause 17. The system of any of clauses 1-16, wherein the frequency pattern comprises one or more of: a daily, weekly, or monthly posting schedule; a time-of-day optimization; or a cadence determined by historical audience engagement data.
Clause 18. The system of any of clauses 1-17, wherein the one or more processors are further configured to determine an optimal posting duration or campaign period for generated content based on platform analytics, target audience availability, or engagement forecasts.
Clause 19. The system of any of clauses 1-18, wherein the artificial intelligence model generates multiple tone variants for a same campaign goal, each variant corresponding to a distinct brand personality or communication style selected by the user.
Clause 20. The system of any of clauses 1-19, wherein the one or more processors are further configured to generate call-to-action (CTA) recommendations tailored to the target audience and platform type, and to incorporate a selected CTA into generated social or messaging content.
Clause 21. A computer-readable medium storing instructions that, when executed by at least one processor, cause the at least one processor to be configured to: receive, at a messaging platform and from a user, a campaign goal and a target audience; access, by an artificial intelligence model, a brand intelligence layer comprising stored brand tone, audience data, and prior messaging context; generate, by the artificial intelligence model, a plurality of content drafts for at least one of a social media platform, an email platform, or a messaging platform; rank, by the artificial intelligence model, the plurality of content drafts based on predicted engagement or resonance to obtain ranked content drafts; provide, to a user interface, the ranked content drafts for review, editing, regeneration, or approval; and store user selections or feedback to refine subsequent messaging generation.
Clause 22. The computer-readable medium of clause 21, wherein the plurality of content drafts comprise one or more of a LinkedIn post, a tweet, an Instagram caption, a social message, an email subject line, or an email body.
Clause 23. The computer-readable medium of any of clauses 21-22, wherein the instructions further cause the at least one processor to apply a probabilistic resonance model trained on engagement metrics, message tone, campaign objectives, and target audience parameters to rank the plurality of content drafts.
Clause 24. The computer-readable medium of any of clauses 21-23, wherein the instructions further cause the at least one processor to incorporate user feedback, edits, and approval history into a machine learning model to fine-tune future messaging generation.
Clause 25. The computer-readable medium of any of clauses 21-24, wherein the instructions further cause the at least one processor to export, via the messaging platform, an approved content draft to an external posting system, an email delivery platform, or a messaging distribution service.
Clause 26. The computer-readable medium of any of clauses 21-25, wherein the instructions further cause the at least one processor to schedule publication of approved content according to a frequency pattern defined by the user or recommended by the artificial intelligence model.
Clause 27. The computer-readable medium of any of clauses 21-26, wherein the frequency pattern comprises one or more of: a daily, weekly, or monthly posting schedule; a time-of-day optimization; or a cadence determined by historical audience engagement data.
Clause 28. The computer-readable medium of any of clauses 21-27, wherein the instructions further cause the at least one processor to determine an optimal posting duration or campaign period for generated content based on platform analytics, target audience availability, or engagement forecasts.
Clause 29. The computer-readable medium of any of clauses 21-28, wherein the instructions further cause the at least one processor to generate multiple tone variants for a same campaign goal, each variant corresponding to a distinct brand personality or communication style selected by the user.
Clause 30. The computer-readable medium of any of clauses 21-29, wherein the instructions further cause the at least one processor to generate call-to-action (CTA) recommendations tailored to the target audience and platform type, and to incorporate a selected CTA into generated social or messaging content.

### Clause Set IV: Mini-Campaign

Clause 1. A method for conducting a mini-campaign and determining messaging resonance using an artificial-intelligence-powered marketing platform, the method comprising: selecting, on a platform and by a user, one or more content assets generated by an artificial-intelligence model, wherein the one or more content assets comprise at least one of a social-media post, an email message, or a landing page to obtain selected content assets; defining, by the user or the artificial-intelligence model, campaign parameters including target audience, delivery channel, posting frequency, and campaign duration; deploying, by the platform, the selected content assets across one or more communication channels to a defined test audience to obtain deployed content assets; collecting, by the platform, engagement data corresponding to the deployed content assets; calculating, by the artificial-intelligence model, a messaging-resonance score based on the engagement data, the campaign parameters, and audience characteristics; presenting, to the user, the messaging-resonance score and one or more recommendations for improving message performance; and updating a brand-intelligence layer with resonance data to refine subsequent message generation and campaign scheduling.
Clause 2. The method of clause 1, wherein the engagement data comprises one or more of impressions, reactions, link clicks, email opens, conversions, or form submissions.
Clause 3. The method of any of clauses 1-2, wherein calculating the messaging-resonance score comprises applying a probabilistic or machine-learning model trained on historical engagement data, audience profiles, tone characteristics, and call-to-action effectiveness.
Clause 4. The method of any of clauses 1-3, further comprising generating, by the artificial-intelligence model, one or more revised content assets incorporating recommendations derived from the messaging-resonance score.
Clause 5. The method of any of clauses 1-4, further comprising automatically adjusting, by the platform, a posting cadence or campaign duration based on real-time engagement data and predicted performance trends.
Clause 6. The method of any of clauses 1-5, wherein the campaign parameters include a time-of-day posting schedule determined by the artificial-intelligence model based on historical audience-engagement data.
Clause 7. The method of any of clauses 1-6, wherein the artificial-intelligence model compares multiple tone or style variants of content assets to identify a highest-performing variant according to the messaging-resonance score.
Clause 8. The method of any of clauses 1-7, further comprising generating an analytics dashboard displaying comparative resonance scores across multiple mini-campaigns, delivery channels, or audience segments.
Clause 9. The method of any of clauses 1-8, wherein the brand-intelligence layer stores the messaging-resonance score, engagement metrics, and audience-response data as training input for refining subsequent predictive models.
Clause 10. The method of any of clauses 1-9, further comprising determining, by the artificial-intelligence model, an overall campaign-effectiveness index combining resonance scores across multiple content assets to guide future messaging strategy.
Clause 11. A system for conducting a mini-campaign and determining messaging resonance using an artificial-intelligence-powered marketing platform, the system comprising: one or more processors; and one or more non-transitory computer-readable media storing instructions that, when executed by the one or more processors, cause the system to: receive a selection, by a user, one or more content assets generated by an artificial-intelligence model, wherein the one or more content assets comprise at least one of a social-media post, an email message, or a landing page to obtain selected content assets; receive a definition, by the user or the artificial-intelligence model, campaign parameters including target audience, delivery channel, posting frequency, and campaign duration; deploy the selected content assets across one or more communication channels to a defined test audience to obtain deployed content assets; collect engagement data corresponding to the deployed content assets; calculate, by the artificial-intelligence model, a messaging-resonance score based on the engagement data, the campaign parameters, and audience characteristics; present, to the user, the messaging-resonance score and one or more recommendations for improving message performance; and update a brand-intelligence layer with resonance data to refine subsequent message generation and campaign scheduling.
Clause 12. The system of clause 11, wherein the engagement data comprises one or more of impressions, reactions, link clicks, email opens, conversions, or form submissions.
Clause 13. The system of any of clauses 11-12, wherein the one or more processors are configured to apply a probabilistic or machine-learning model trained on historical engagement data, audience profiles, tone characteristics, and call-to-action effectiveness to calculate the messaging-resonance score.
Clause 14. The system of any of clauses 11-13, wherein the one or more processors are further configured to generate, by the artificial-intelligence model, one or more revised content assets incorporating recommendations derived from the messaging-resonance score.
Clause 15. The system of any of clauses 11-14, wherein the one or more processors are further configured to automatically adjust a posting cadence or campaign duration based on real-time engagement data and predicted performance trends.
Clause 16. The system of any of clauses 11-15, wherein the campaign parameters include a time-of-day posting schedule determined by the artificial-intelligence model based on historical audience-engagement data.
Clause 17. The system of any of clauses 11-16, wherein the artificial-intelligence model compares multiple tone or style variants of content assets to identify a highest-performing variant according to the messaging-resonance score.
Clause 18. The system of any of clauses 11-17, wherein the one or more processors are further configured to generate an analytics dashboard displaying comparative resonance scores across multiple mini-campaigns, delivery channels, or audience segments.
Clause 19. The system of any of clauses 11-18, wherein the brand-intelligence layer stores the messaging-resonance score, engagement metrics, and audience-response data as training input for refining subsequent predictive models.
Clause 20. The system of any of clauses 11-19, wherein the one or more processors are further configured to determine an overall campaign-effectiveness index combining resonance scores across multiple content assets to guide future messaging strategy.
Clause 21. A computer-readable medium storing instructions that, when executed by at least one processor, cause the at least one processor to be configured to: receive a selection, by a user, one or more content assets generated by an artificial-intelligence model, wherein the one or more content assets comprise at least one of a social-media post, an email message, or a landing page to obtain selected content assets; receive a definition, by the user or the artificial-intelligence model, campaign parameters including target audience, delivery channel, posting frequency, and campaign duration; deploy the selected content assets across one or more communication channels to a defined test audience to obtain deployed content assets; collect engagement data corresponding to the deployed content assets; calculate, by the artificial-intelligence model, a messaging-resonance score based on the engagement data, the campaign parameters, and audience characteristics; present, to the user, the messaging-resonance score and one or more recommendations for improving message performance; and update a brand-intelligence layer with resonance data to refine subsequent message generation and campaign scheduling.
Clause 22. The computer-readable medium of clause 21, wherein the engagement data comprises one or more of impressions, reactions, link clicks, email opens, conversions, or form submissions.
Clause 23. The computer-readable medium of any of clauses 21-22, wherein execution of the instructions causes the at least one processor to apply a probabilistic or machine-learning model trained on historical engagement data, audience profiles, tone characteristics, and call-to-action effectiveness to calculate the messaging-resonance score.
Clause 24. The computer-readable medium of any of clauses 21-23, wherein execution of the instructions further causes the at least one processor to generate, by the artificial-intelligence model, one or more revised content assets incorporating recommendations derived from the messaging-resonance score.
Clause 25. The computer-readable medium of any of clauses 21-24, wherein execution of the instructions further causes the at least one processor to automatically adjust a posting cadence or campaign duration based on real-time engagement data and predicted performance trends.
Clause 26. The computer-readable medium of any of clauses 21-25, wherein the campaign parameters include a time-of-day posting schedule determined by the artificial-intelligence model based on historical audience-engagement data.
Clause 27. The computer-readable medium of any of clauses 21-26, wherein execution of the instructions further causes the at least one processor to compare multiple tone or style variants of the content assets to identify a highest-performing variant according to the messaging-resonance score.
Clause 28. The computer-readable medium of any of clauses 21-27, wherein execution of the instructions further causes the at least one processor to generate an analytics dashboard displaying comparative resonance scores across multiple mini-campaigns, delivery channels, or audience segments.
Clause 29. The computer-readable medium of any of clauses 21-28, wherein execution of the instructions further causes the at least one processor to store the messaging-resonance score, engagement metrics, and audience-response data as training input for refining subsequent predictive models.
Clause 30. The computer-readable medium of any of clauses 21-29, wherein execution of the instructions further causes the at least one processor to determine an overall campaign-effectiveness index combining resonance scores across multiple content assets to guide future messaging strategy.

### Clause Set V: Generating a Messaging Framework

Clause 1. A method comprising receiving, from a user device, a plurality of business documents and structured question-and-answer inputs relating to a marketing project; automatically enriching the received information with external market and brand-reputation data to generate an augmented information set; generating, by an artificial-intelligence model, a project brief comprising structured attributes including a target audience, brand tone, and differentiators; obtaining user approval of at least one foundation parameter selected from the group consisting of the target audience, the brand tone, and a brand voice; chaining the approved foundation parameter as contextual conditioning data for downstream messaging generation; and generating, based on the chained contextual data, a multi-section messaging framework comprising at least one of a positioning statement, brand promise, tagline, headline, or campaign message.
Clause 2. The method of Clause 1, wherein the plurality of business documents include at least one of brand guidelines, marketing collateral, voice-of-customer transcripts, or competitive analysis materials.
Clause 3. The method of any of Clauses 1-2, wherein enriching the received information comprises retrieving open-source or proprietary market data via background agents and embedding such data into the augmented information set.
Clause 4. The method of any of Clauses 1-3, further comprising maintaining a hierarchical record structure in which a plurality of clients are each associated with one or more projects, each project defining a distinct marketing objective.
Clause 5. The method of any of Clauses 1-4, further comprising presenting to the user a guided question interface that elicits missing data items when the received documents lack sufficient context.
Clause 6. The method of any of Clauses 1-5, wherein selected questions are transmitted to a remote client portal for asynchronous completion and merged into the augmented information set upon receipt.
Clause 7. The method of any of Clauses 1-6, wherein generating the project brief includes segmenting the augmented information set into thematic content chunks and summarizing each chunk into insight fields of the brief.
Clause 8. The method of any of Clauses 1-7, wherein the user edits or regenerates individual sections of the project brief until the system confirms semantic consistency among the sections.
Clause 9. The method of any of Clauses 1-8, wherein obtaining user approval of the foundation parameter initiates storage of an immutable foundation version, and subsequent edits trigger a cascading regeneration of dependent outputs.
Clause 10. The method of any of Clauses 1-9, further comprising providing a prompt-assistance interface that displays suggested prompt modifications or exemplar phrasings generated by the artificial-intelligence model in real time.
Clause 11. The method of any of Clauses 1-10, wherein the prompt-assistance interface adapts its suggestions based on the user's historical edits, tone preferences, and prior campaign outcomes.
Clause 12. The method of any of Clauses 1-11, further comprising classifying sections of the messaging framework as one of core elements or creative assets, and grouping the creative assets for separate export or white-label client delivery.
Clause 13. The method of any of Clauses 1-12, wherein the creative assets include taglines, headlines, social-media posts, emails, and landing-page copy each generated according to template-specific AI prompts.
Clause 14. The method of any of Clauses 1-13, further comprising computing a resonance score representing a predicted effectiveness of the messaging framework based on linguistic, emotional, and contextual metrics derived from prior campaigns.
Clause 15. The method of any of Clauses 1-14, further comprising storing the resonance score in association with the project and using the stored score to train a predictive feedback model for subsequent messaging generation.
Clause 16. The method of any of Clauses 1-15, wherein the user selectively refines all sections of the messaging framework by issuing a “refine-all” command that triggers minor prompt recalibration without regenerating the foundation parameters.
Clause 17. The method of any of Clauses 1-16, wherein the user selectively regenerates all sections of the messaging framework by issuing a “regenerate-all” command that retrains or re-executes prompts based on a modified foundation parameter.
Clause 18. The method of any of Clauses 1-17, further comprising enabling multiple users to collaborate on a single project in real time, each user's actions being recorded with timestamps and merged into a shared workspace version history.
Clause 19. The method of any of Clauses 1-18, further comprising locking selected sections of the messaging framework responsive to an approval state to prevent concurrent edits prior to client export.
Clause 20. The method of any of Clauses 1-19, wherein providing the messaging framework for review further comprises exporting a formatted, client-ready document and optionally transmitting the document to a client feedback module integrated within the platform.
Clause 21. The method of any of Clauses 1-20, further comprising providing the messaging framework for review, refinement, and export as a client-ready output.
Clause 22. The method of any of Clauses 1-21, further comprising generating, by the artificial-intelligence model, a set of creative assets derived from the messaging framework, the creative assets including one or more of taglines, headlines, emails, social-media posts, or landing-page copy.
Clause 23. The method of any of Clauses 1-22, further comprising exporting the set of creative assets to at least one output channel.
Clause 24. The method of Clause 23, wherein the output channel comprises at least one of a social-media platform, a landing page of a website or application, an email-distribution service, or a messaging platform configured for text messaging.
Clause 25. The method of any of Clauses 1-24, wherein exporting the set of creative assets includes formatting the creative assets according to respective output-channel templates.
Clause 26. The method of any of Clauses 1-25, further comprising monitoring delivery or engagement metrics associated with the exported creative assets and storing the metrics for use in subsequent resonance-score computation.
Clause 27. A system comprising one or more processors and memory storing instructions that, when executed, cause the system to: (a) receive, from a user device, a plurality of business documents and structured question-and-answer inputs relating to a marketing project; (b) automatically enrich the received information with external market and brand-reputation data to generate an augmented information set; (c) generate, by an artificial-intelligence model, a project brief comprising structured attributes including a target audience, brand tone, and differentiators; (d) obtain user approval of at least one foundation parameter selected from the group consisting of the target audience, the brand tone, and a brand voice; (e) chain the approved foundation parameter as contextual conditioning data for downstream messaging generation; and (f) generate, based on the chained contextual data, a multi-section messaging framework comprising at least one of a positioning statement, brand promise, tagline, headline, or campaign message.
Clause 28. The system of Clause 27, wherein the system includes a client-management module configured to maintain hierarchical associations between clients, projects, and related brand files.
Clause 29. The system of any of Clauses 27-28, further comprising a background-agent subsystem configured to retrieve open-source or proprietary market data for use in generating augmented information sets.
Clause 30. The system of any of Clauses 27-29, wherein the system includes a guided-question interface engine operable to present missing-data prompts and merge received responses into the augmented information set.
Clause 31. The system of any of Clauses 27-30, further comprising a semantic-consistency validator configured to compare edited project-brief sections and enforce alignment of tone and audience parameters.
Clause 32. The system of any of Clauses 27-31, wherein a foundation-version manager stores immutable foundation parameters and triggers cascading regeneration of dependent outputs upon change detection.
Clause 33. The system of any of Clauses 27-32, further comprising a prompt-assistance interface module operable to generate, display, and update prompt suggestions based on real-time user interactions.
Clause 34. The system of any of Clauses 27-33, wherein the prompt-assistance module utilizes prior user edits and performance metrics to adapt prompt templates.
Clause 35. The system of any of Clauses 27-34, further comprising an asset-generation engine configured to output taglines, headlines, social posts, emails, and landing-page copy using template-specific prompt structures.
Clause 36. The system of any of Clauses 27-35, wherein the asset-generation engine groups creative assets for white-label export.
Clause 37. The system of any of Clauses 27-36, further comprising a resonance-scoring engine configured to compute and store performance metrics for each generated messaging framework.
Clause 38. The system of any of Clauses 27-37, wherein the resonance-scoring engine provides feedback weights to a training model that influences future prompt generation.
Clause 39. The system of any of Clauses 27-38, further comprising a collaboration module providing real-time shared editing, comment threading, and state locking across multiple users.
Clause 40. The system of any of Clauses 27-39, wherein the collaboration module records activity metadata for version tracking and rollback.
Clause 41. The system of any of Clauses 27-40, further comprising a section-locking manager that prevents editing of approved content regions pending client release.
Clause 42. The system of any of Clauses 27-41, wherein the system includes a scheduler configured to regenerate messaging frameworks periodically or responsive to external data changes.
Clause 43. The system of any of Clauses 27-42, wherein regeneration events generate versioned frameworks linked to the original foundation approval record.
Clause 44. The system of any of Clauses 27-43, further comprising an export manager operable to compile framework content and creative assets into formatted client deliverables.
Clause 45. The system of any of Clauses 27-44, wherein the export manager interfaces with a feedback service for client commentary and approval logging.
Clause 46. The system of any of Clauses 27-45, wherein the processors are further configured to aggregate client feedback across multiple projects to retrain prompt templates and scoring algorithms.
Clause 47. The system of any of Clauses 27-46, wherein the processors are further to provide the messaging framework for review, refinement, and export as a client-ready output.
Clause 48. The system of any of Clauses 27-47, further configured to generate, by the artificial-intelligence model, a set of creative assets derived from the messaging framework, the creative assets including one or more of taglines, headlines, emails, social-media posts, or landing-page copy.
Clause 49. The system of any of Clauses 27-48, further configured to export the set of creative assets to at least one output channel.
Clause 50. The system of any of Clauses 27-49, wherein the output channel comprises at least one of a social-media platform, a landing page of a website or application, an email-distribution service, or a messaging platform configured for text messaging.
Clause 51. The system of any of Clauses 27-50, wherein exporting includes formatting each creative asset according to a template corresponding to the target output channel.
Clause 52. The system of any of Clauses 27-51, wherein the system further includes a monitoring component configured to record engagement metrics associated with the exported creative assets for subsequent performance analysis.
Clause 53. A non-transitory computer-readable medium storing instructions that, when executed by one or more processors, cause performance of steps comprising: (a) receiving, from a user device, a plurality of business documents and structured question-and-answer inputs relating to a marketing project; (b) automatically enriching the received information with external market and brand-reputation data to generate an augmented information set; (c) generating, by an artificial-intelligence model, a project brief comprising structured attributes including a target audience, brand tone, and differentiators; (d) obtaining user approval of at least one foundation parameter selected from the group consisting of the target audience, the brand tone, and a brand voice; (e) chaining the approved foundation parameter as contextual conditioning data for downstream messaging generation; and (f) generating, based on the chained contextual data, a multi-section messaging framework comprising at least one of a positioning statement, brand promise, tagline, headline, or campaign message.
Clause 54. The computer-readable medium of Clause 53, wherein the instructions cause the medium to provide the generated messaging framework for user review, refinement, and export as a client-ready output document.
Clause 55. The computer-readable medium of any of Clauses 53-54, wherein the instructions cause generation, by the artificial-intelligence model, of a set of creative assets derived from the messaging framework, the creative assets including one or more of taglines, headlines, emails, social-media posts, or landing-page copy.
Clause 56. The computer-readable medium of any of Clauses 53-55, wherein the instructions cause exporting of the set of creative assets to at least one output channel.
Clause 57. The computer-readable medium of any of Clauses 53-56, wherein the output channel comprises at least one of a social-media platform, a landing page of a website or application, an email-distribution service, or a messaging platform configured for text messaging.
Clause 58. The computer-readable medium of any of Clauses 53-57, wherein the instructions cause formatting of each creative asset according to a template corresponding to the selected output channel prior to export.
Clause 59. The computer-readable medium of any of Clauses 53-58, wherein the instructions cause monitoring of delivery or engagement metrics associated with the exported creative assets and storing of those metrics for use in subsequent performance analysis or resonance-score computation.
Clause 60. The computer-readable medium of any of Clauses 53-59, wherein the instructions implement refinement and regeneration operations that respectively recalibrate or re-execute prompts based on user modifications to foundation parameters.
Clause 61. The computer-readable medium of any of Clauses 53-60, wherein the instructions store immutable versions of approved foundation parameters and trigger cascading regeneration of dependent outputs upon detection of changes to the approved parameters.
Clause 62. The computer-readable medium of any of Clauses 53-61, wherein the instructions present a guided-question interface that elicits missing information and merges received answers into the augmented information set.
Clause 63. The computer-readable medium of any of Clauses 53-62, wherein the instructions merge asynchronously received client responses into an active project data store associated with the marketing project.
Clause 64. The computer-readable medium of any of Clauses 53-63, wherein the instructions adapt prompt-assistance suggestions in real time based on the user's historical edits, tone preferences, and prior campaign results.
Clause 65. The computer-readable medium of any of Clauses 53-64, wherein the instructions generate and display a prompt-assistance interface providing exemplar phrasings and modified prompts for guiding user interaction with the artificial-intelligence model.
Clause 66. The computer-readable medium of any of Clauses 53-65, wherein the instructions classify messaging-framework sections as core elements or creative assets and group the creative assets for separate export or white-label delivery.
Clause 67. The computer-readable medium of any of Clauses 53-66, wherein the instructions compute a resonance score representing a predicted effectiveness of the messaging framework based on linguistic, emotional, and contextual metrics.
Clause 68. The computer-readable medium of any of Clauses 53-67, wherein the instructions store the resonance score in association with the marketing project and apply the score as feedback data for retraining a predictive model used in future messaging generation.
Clause 69. The computer-readable medium of any of Clauses 53-68, wherein the instructions enable multiple users to collaborate concurrently on a single project, each user's activity being recorded with timestamps and merged into a shared workspace version history.
Clause 70. The computer-readable medium of any of Clauses 53-69, wherein the instructions lock selected sections of the messaging framework responsive to an approval state to prevent concurrent editing prior to client export.
Clause 71. The computer-readable medium of any of Clauses 53-70, wherein the instructions schedule automatic regeneration of messaging frameworks periodically or responsive to detection of new external data.
Clause 72. The computer-readable medium of any of Clauses 53-71, wherein the instructions maintain version-controlled records linking each regenerated framework to its corresponding approved foundation parameters.
Clause 73. The computer-readable medium of any of Clauses 53-72, wherein the instructions compile framework content and generated creative assets into formatted deliverables suitable for client review and approval.
Clause 74. The computer-readable medium of any of Clauses 53-73, wherein the instructions transmit client-ready deliverables to a feedback service configured to capture comments and approval status.
Clause 75. The computer-readable medium of any of Clauses 53-74, wherein the instructions aggregate engagement metrics and client feedback across multiple projects to update prompt templates and scoring algorithms used by the artificial-intelligence model.
Clause 76. The computer-readable medium of any of Clauses 53-75, wherein the instructions execute export, feedback, and performance-metric updates as a continuous workflow cycle for iterative improvement of messaging generation.

### Clause Set VI: Clause from the Provisional Patent Application

Clause 1. An apparatus for generating a message framework, the apparatus comprising: at least one processor; and a computer-readable medium storing instructions, which, when executed by the at least one processor, cause the at least one processor to be configured to: receive, via a user interface, a request to create a new messaging project; receive project details and project goals associated with the new messaging project; generate an artificial intelligence package comprises the project details, project goals and instructions to an artificial intelligence model, the instructions comprising at least one or more of: (1) a request to generate a summary associated with the new messaging project, (2) a request to generate a draft of the messaging framework; (3) a request to generate a plagiarism check associated with the new messaging project; submit the artificial intelligence package to the artificial intelligence model and (4) a request to modify/regenerate an object in the messaging framework, wherein the draft of the messaging framework comprises a plurality of sections and each section of the plurality of sections comprises a respective result; receive the draft of the messaging framework from the artificial intelligence model; present, via a project dashboard of the user interface, the draft of the messaging framework, the project dashboard enabling a user to view the respective result in each section of the plurality of sections and to perform operations on the respective result; and receive, from the user and via the project dashboard, an edit of the respective result to generate an edited messaging framework.
Clause 2. The apparatus of clause 1, wherein the computer-readable medium stores instructions, which, when executed by the at least one processor, cause the at least one processor to be configured to: receive, via the project dashboard, a request to regenerate a chosen section of the plurality of sections, the request comprising at least a revision instruction; generate a revision package associated with the revision instruction and the request to regenerate the chosen section; submit the revision package to the artificial intelligence model to generate a revised section; receive the revised section from the artificial intelligence model; and update the draft of the messaging framework by replacing the chosen section with the revised section.
Clause 3. The apparatus of clause 2 or any previous clause, wherein the revision package comprises revision instructions from the user to guide the artificial intelligence model to generate the revision package, wherein the revision instructions are received via the project dashboard.
Clause 4. The apparatus of any previous clause, wherein the draft of the messaging framework comprises, based on the request to generate the plagiarism check, a plagiarism score from the artificial intelligence model that is associated with a probability that plagiarism exists within the draft of the messaging framework.
Clause 5. The apparatus of any previous clause, wherein the computer-readable medium stores instructions, which, when executed by the at least one processor, cause the at least one processor to be configured to: invite a client associated with the new messaging project to answer a set of questions; obtain a set of answers to a set of questions associated with a client and in connection with the new messaging project; and enable, via the user interface, the user to add notes per question, wherein the artificial intelligence package includes the set of questions, the set of answers and the notes per question.
Clause 6. The apparatus of clause 5 or any previous clause, wherein the set of questions relate to one or more of personal experiences of the client, a business of the client, a goal of client, an experience in a history of the business of the client, and data about an offering of goods or services.
Clause 7. The apparatus of any previous clause, wherein the computer-readable medium stores instructions, which, when executed by the at least one processor, cause the at least one processor to be configured to: receive, via an interaction with a selectable object, a request so summarize and/or edit a chosen response to a chosen question; generate a summary/edit package for the artificial intelligence model, the summary/edit package comprising the chosen question, the chosen response and an instruction to generate a summary response comprising a summary and/or edit of the chosen response to the chosen question; and receive the summary response from the artificial intelligence model.
Clause 8. The apparatus of any previous clause, wherein the draft of the messaging framework comprises at least one plagiarism score generated by the artificial intelligence model based on the request to generate the plagiarism check associated with the new messaging project.
Clause 9. The apparatus of clause 8 or any previous clause, wherein the draft of the messaging framework further comprises a description of one or more phrases in the new messaging project and why the one or more phrases present or do not present a plagiarism issue based on the plagiarism check.
Clause 10. The apparatus of any previous clause, wherein the draft of the messaging framework comprises one or more of: a first section describing a target audience, a second section describing a brand tone of voice and personality, a third section describing a company description, a fourth section describing an elevator pitch, a fifth section describing a brand statement, a sixth section describing a brand promise, a seventh section describing brand promised benefits, an eighth section describing brand pillars, a ninth section describing pillar benefits, a tenth section describing core differentiators, an eleventh section describing a value/benefit to a customer, a twelfth section describing a value/benefit description, a thirteenth section describing a value proposition, a fourteenth section describing a mission statement, a fifteenth section describing possible taglines and brand statements and a sixteenth section describing possible headlines.
Clause 11. A method for generating a message framework, the method comprising: receiving, via a user interface, a request to create a new messaging project; receiving project details and project goals associated with the new messaging project; generating an artificial intelligence package comprises the project details, project goals and instructions to an artificial intelligence model, the instructions comprising at least one or more of: (1) a request to generate a summary associated with the new messaging project, (2) a request to generate a draft of the messaging framework; (3) a request to generate a plagiarism check associated with the new messaging project and (4) a request to modify/regenerate an object in the draft of the messaging framework; submitting the artificial intelligence package to the artificial intelligence model, wherein the artificial intelligence model generates the draft of the messaging framework, wherein the draft of the messaging framework comprises a plurality of sections and each section of the plurality of sections comprises a respective result; receiving the draft of the messaging framework from the artificial intelligence model; presenting, via a project dashboard of the user interface, the draft of the messaging framework, the project dashboard enabling a user to view the respective result in each section of the plurality of sections and to perform operations on the respective result; and receiving, from the user and via the project dashboard, an edit of the respective result to generate an edited messaging framework.
Clause 12. The method of clause 11, wherein the method further comprises: receiving, via the project dashboard, a request to regenerate a chosen section of the plurality of sections, the request comprising at least a revision instruction; generating a revision package associated with the revision instruction and the request to regenerate the chosen section; submitting the revision package to the artificial intelligence model to generate a revised section; receiving the revised section from the artificial intelligence model; and updating the draft of the messaging framework by replacing the chosen section with the revised section.
Clause 13. The method of any of clauses 11-12, wherein the revision package comprises revision instructions from the user to guide the artificial intelligence model to generate the revision package, wherein the revision instructions are received via the project dashboard.
Clause 14. The method of any of clauses 11-13, wherein the draft of the messaging framework comprises, based on the request to generate the plagiarism check, a plagiarism score from the artificial intelligence model that is associated with a probability that plagiarism exists within the draft of the messaging framework.
Clause 15. The method of any of clauses 11-14, wherein the method further comprises: inviting a client associated with the new messaging project to answer a set of questions; obtaining a set of answers to a set of questions associated with a client and in connection with the new messaging project; and enabling, via the user interface, the user to add notes per question, wherein the artificial intelligence package includes the set of questions, the set of answers and the notes per question.
Clause 16. The method of any of clauses 11-15, wherein the set of questions relate to one or more of personal experiences of the client, a business of the client, a goal of client, an experience in a history of the business of the client, and data about an offering of goods or services.
Clause 17. The method of any of clauses 11-16, wherein the method further comprises: receiving, via an interaction with a selectable object, a request so summarize and/or edit a chosen response to a chosen question; generating a summary/edit package for the artificial intelligence model, the summary/edit package comprising the chosen question, the chosen response and an instruction to generate a summary response comprising a summary and/or edit of the chosen response to the chosen question; and receiving the summary response from the artificial intelligence model.
Clause 18. The method of any of clauses 11-17, wherein the draft of the messaging framework comprises at least one plagiarism score generated by the artificial intelligence model based on the request to generate the plagiarism check associated with the new messaging project.
Clause 19. The method of any of clauses 11-18, wherein the draft of the messaging framework further comprises a description of one or more phrases in the new messaging project and why the one or more phrases present or do not present a plagiarism issue based on the plagiarism check.
Clause 20. The method of any of clauses 11-19, wherein the draft of the messaging framework comprises one or more of: a first section describing a target audience, a second section describing a brand tone of voice and personality, a third section describing a company description, a fourth section describing an elevator pitch, a fifth section describing a brand statement, a sixth section describing a brand promise, a seventh section describing brand promised benefits, an eighth section describing brand pillars, a ninth section describing pillar benefits, a tenth section describing core differentiators, an eleventh section describing a value/benefit to a customer, a twelfth section describing a value/benefit description, a thirteenth section describing a value proposition, a fourteenth section describing a mission statement, a fifteenth section describing possible taglines and brand statements and a sixteenth section describing possible headlines.

What is claimed is:

1. A method of operating a brand messaging artificial intelligence pipeline, the method comprising:
receiving a set of documents, from a user, wherein the set of documents relates to a business;
activating, based on the set of documents, a brand intelligence layer that processes and embeds business data related to the set of documents for the business to generate a sphere associated with the business and to enable the business data to be available for context-aware retrieval by an artificial intelligence model;
generating, based on the set of documents and the sphere, a project brief; accessing, by the artificial intelligence model, the sphere for context;
transmitting the project brief to the artificial intelligence model; and
generating, based on the project brief, the context and via the artificial intelligence model, a messaging framework, wherein the artificial intelligence model is trained on go-to-market strategies, messaging architectures, and real-world marketing nuance data.

2. The method of claim 1, wherein the set of documents is editable and is configured to be provided downstream to an artificial intelligence marketing model.

3. The method of claim 1, wherein the project brief comprises structured summaries of the set of documents and synthesizes one or more of a tone, an audience, positioning data and a market differentiator for the business.

4. The method of claim 1, wherein the set of documents comprises one or more of client survey data, a sales pitch deck, brand guidelines, a video, an audio file, a voice of customer call transcripts, a scope of work, a project brief, a demonstration recording, and an internal call with an agency or marketing team.

5. The method of claim 1, wherein the business data comprises the set of documents and one or more of past messaging, inputs, frameworks and iterations of data such that the sphere comprises a persistent workspace that is accessed by the artificial intelligence model for the context when generating the messaging framework.

6. The method of claim 1, wherein the set of documents comprises content in diverse file formats and wherein generating the project brief further comprises preprocessing the set of documents into text chunks.

7. The method of claim 1, further comprising:
presenting the project brief to the user for revision; and
receiving revisions to the project brief before transmitting the project brief to the artificial intelligence model.

8. The method of claim 1, further comprising:
prior to generating the messaging framework:
presenting, based on the project brief and from the artificial intelligence model, a brand tone and a target audience to the user based on the project brief;
receiving one or more of edits to the brand tone or the target audience and a confirmation of the brand tone and the target audience; and
updating, if relevant, prompts to the artificial intelligence model based on any edits to the brand tone or the target audience for generation of the messaging framework.

9. The method of claim 1, wherein the messaging framework comprises a multi-section brand messaging framework.

10. The method of claim 9, wherein the multi-section brand messaging framework comprises two or more sections chosen from a list consisting of: a target audience, a brand tone, a voice, a personality, a company category, a company description, an elevator pitch, a positioning statement, a brand statement, a brand promise, brand promise benefits, brand pillars, brand pillar benefits, core differentiators, value/benefit to target audience, a value/benefit description, taglines and headlines.

11. The method of claim 1, wherein the artificial intelligence model comprises a selected artificial intelligence model selected from a group of artificial intelligence models in which each artificial intelligence model of the group of artificial intelligence models is trained on specific industries or styles for marketing purposes.

12. The method of claim 1, further comprising:
creating, based on the messaging framework, one or more asset comprising an email, a website landing page, and a social media post.

13. The method of claim 1, further comprising:
storing and refining inputs, tone preferences and past messaging frameworks to obtain stored historical data; and
building a business-specific artificial intelligence model, based on the artificial intelligence model and on the stored historical data and for generating further messaging frameworks.

14. The method of claim 1, wherein the sphere is stored in a vector database and wherein the set of documents is transformed from unstructured brand-related inputs into the sphere and wherein the sphere comprises a target audience and one or more of a brand tone and a brand voice.

15. The method of claim 3, wherein the structured summaries in the project brief synthesizes key attributing including one or more of a target audience, a brand tone, a personality, one or more core differentiators, a positioning, a key messaging theme, an emotional deriver, a company description and a notable brand quote.

16. The method of claim 1, further comprising:
generating, pre-market and via a probability model, a resonance score related to pre-market validation of the messaging framework, wherein the resonance score is generated from a probability model built on one or more of a campaign goal, an industry context, a target audience profile, a desired emotional response, an intended action and a delivery channel.

17. The method of claim 16, wherein the delivery channel comprises one or more of an email channel, a social media channel, a web channel, an application channel and a texting channel.

18. The method of claim 17, wherein the sphere is chained to all downstream outputs to maintain consistency over the target audience, the brand tone or the brand voice.

19. The method of claim 1, further comprising:
obtaining competitor data by monitoring competitor marketing activities;
adding the competitor data to the business data in the sphere to obtain updated business data; and
performing context-aware retrieval, via use of the updated business data, by the artificial intelligence model.

20. The method of claim 1, further comprising:
receiving a selection, from a library of brains, of a brain for guiding the artificial intelligence model regarding a prompt framework and messaging framework generation specific to a vertical or style associated with the brain.

21. An apparatus for generating a message framework, the apparatus comprising:
at least one processor; and
a computer-readable medium storing instructions, which, when executed by the at least one processor, cause the at least one processor to be configured to:
receive a set of documents, from a user, wherein the set of documents relates to a business;
activate, based on the set of documents, a brand intelligence layer that processes and embeds business data related to the set of documents for the business to generate a sphere associated with the business and to enable the business data to be available for context-aware retrieval by an artificial intelligence model;
generate, based on the set of documents and the sphere, a project brief;
access, by the artificial intelligence model, the sphere for context; transmit the project brief to the artificial intelligence model; and
generate, based on the project brief, the context and via the artificial intelligence model, a messaging framework, wherein the artificial intelligence model is trained on go-to-market strategies, messaging architectures, and real-world marketing nuance data.
